(19) United States
(12) Patent Application Publication
(10) Pub. No.: US 2025/0388363 A1
(43) Pub. Date: Dec. 25, 2025

(54) STACKING ASSEMBLY AND STACKING SYSTEM

(71) Applicant: HANGZHOU GREAT STAR INDUSTRIAL CO., LTD., Hangzhou (CN)

(72) Inventor: Yueming LI, Hangzhou (CN)

(21) Appl. No.: 19/314,258

(22) Filed: Aug. 29, 2025

Related U.S. Application Data
(63) Continuation of application No. PCT/CN2023/097830, filed on Jun. 1, 2023.

(30) Foreign Application Priority Data
Mar. 17, 2023 (CN) 202320568831.3

(51) Int. Cl. B65D 21/02; B65D 43/16; B65D 43/22

(52) U.S. Cl. CPC B65D 21/0223; B65D 43/167; B65D 43/22; B65D 2543/00194; B65D 2543/00296

(57) ABSTRACT

A stacking assembly and a stacking system are provided. The stacking assembly has an accommodating space. The stacking assembly includes a first connecting member and a second connecting member. The first connecting member is configured to form at least one of an upper surface of the stacking assembly and a lower surface of the stacking assembly. The second connecting member is connected to the first connecting member to form the accommodating space. A material of the first connecting member is different from a material of the second connecting member.

### CROSS-REFERENCE TO RELATED APPLICATIONS

This application is a continuation of international patent application No. PCT/CN2023/097830, filed on Jun. 1, 2023, which itself claims priority to Chinese patent application No. 202320568831.3, filed on Mar. 17, 2023, and titled “STACKING SYSTEM”. The contents of the above identified applications are hereby incorporated herein in their entireties by reference.

### TECHNICAL FIELD

The present disclosure relates to the field of storage technology, and in particular, to a stacking assembly and a stacking system.

### BACKGROUND

In a related technology, in order to facilitate processing, a stacking assembly for storing an item, such as a storage box, a storage basket and so on, are generally made of the same material. However, when the same material is processed as a whole, it is often difficult to have different functional characteristics for different parts of the stacking assembly and meet various requirements.

### SUMMARY

According to various embodiments of the present disclosure, a stacking assembly and a stacking system are provided.

The stacking assembly having an accommodating space includes a first connecting member and a second connecting member. The first connecting member is configured to form at least one of an upper surface of the stacking assembly and a lower surface of the stacking assembly. The second connecting member is connected to the first connecting member to form the accommodating space. A material of the first connecting member is different from a material of the second connecting member.

In an embodiment, the first connecting member is made of plastic, and the second connecting member is made of metal.

In an embodiment, the first connecting member includes an upper cover and a lower cover. The second connecting member includes an intermediate housing. The upper cover and the lower cover are mounted on two opposite sides of the intermediate housing, respectively. An opening is defined on at least one side of the intermediate housing. The upper cover is configured to cover the opening to form the enclosed accommodating space.

In an embodiment, the stacking assembly further includes a connecting mechanism. The upper cover is movably connected to the intermediate housing via the connecting mechanism.

In an embodiment, the connecting mechanism includes a sliding component and a sliding mating portion that cooperate with each other. One of the sliding component and the sliding mating portion is disposed on the upper cover, and the other one of the sliding component and the sliding mating portion is disposed on the intermediate housing. The upper cover is capable of being slidably connected to the intermediate housing via cooperation between the sliding component and the sliding mating portion.

In an embodiment, the sliding component includes a slider rail disposed on the upper cover, and the sliding mating portion includes a slide groove disposed on the intermediate housing.

In an embodiment, the sliding groove includes a side notch and two opposite end openings. The side notch and the two end openings are in communication with each other. An opening of the side notch is disposed towards a side of the stacking assembly, and at least one of the two end openings is configured to allow the slider rail to slide from a side of the intermediate housing to the slide groove, so as to prevent the upper cover from detaching from the intermediate housing.

In an embodiment, an inner wall of the slide groove is provided with a stopping protrusion. When a force applied on the upper cover reaches to a preset value, the slider rail is capable of overcoming a resistance of the stopping protrusion and detaching from the slide groove.

In an embodiment, the connecting mechanism includes a first connecting component and a first engaging assembly, a first side of the upper cover is rotatably connected to the intermediate housing via the first connecting mechanism, and a second side of the upper cover, opposite to the first side of the upper cover, is snapped onto the intermediate housing via the first engaging assembly.

In an embodiment, the first engaging assembly includes a first engaging member and a first mating portion. The first engaging member is disposed on one of the upper cover and the intermediate housing. The first mating portion is disposed on the other one of the upper cover and the intermediate housing. The first engaging member and the first mating portion both have a mating state and a separating state. When the first engaging member and the first fitting component are at the mating state, the upper cover is fixedly connected to the intermediate housing, so as to enclose the opening. When the first engaging member and the first fitting component are at the separating state, the upper cover is capable of flipping relative to the intermediate housing, so as to expose the opening.

In an embodiment, the first mating portion includes a first stopper and a second stopper. The first stopper is connected to the second stopper. The first stopper protrudes from a periphery wall of the intermediate housing. The second stopper protrudes from a side of the first stopper away from the upper cover. An engaging gap is defined between the second stopper and the intermediate housing. The first engaging member is rotatably mounted on the upper cover. The first engaging member is capable of being snapped into or detached from the engaging gap via an external force.

In an embodiment, a side of the second stopper towards the intermediate housing is provided with a first inclined guiding surface. An inclined direction of the first inclined guiding surface is downward and away from a side of the intermediate housing. The first inclined guiding surface is configured to guide when the first engaging member is detached from the engaging gap. Alternatively, the first stopper is integrated with the second stopper.

In an embodiment, the first engaging assembly further includes two mounting protrusions. The first engaging member is a U-shaped rod which is rotatably mounted between the two mounting protrusions.

In an embodiment, the stacking assembly includes a fixing member. A side of the intermediate housing, opposite to the upper cover, is provided with a connecting plate. The lower cover is connected to the connecting plate via the fixing member. Alternatively, the stacking assembly further includes a fixing member. The lower cover includes a bottom plate and a side plate protruding from a periphery of the bottom plate. A side wall of the intermediate housing is connected to the side plate of the lower cover via the fixing member.

In an embodiment, the stacking assembly further includes a second engaging assembly. The second engaging assembly includes a second engaging member and a second mating portion. One of the second engaging member and the second mating portion is disposed on a bottom of the intermediate housing, and the other one of the second engaging member and the second mating portion is disposed on the lower cover. The second engaging member is capable of engaging with the second mating portion, such that the lower cover is capable of being connected to the bottom of the intermediate housing.

In an embodiment, the second snapping component protrudes from the lower cover. The second snapping component each includes two catching legs disposed at interval. One side, away from each other, of each of the two catching legs is provided with a limiting protrusion. The second mating portion includes a catching slot disposed on the intermediate housing. The two catching legs are capable of deforming and extending to the same catching slot or to two catching slots, respectively, via an external force. Two limiting protrusions are snapped into the same catching slot or into the two catching slots, respectively, after removing the external force.

In an embodiment, one side, away from each other, of each of the two limiting protrusions is provided with a second inclined guiding surface. The second inclined guiding surface is configured to play a guiding role when the second engaging member is snapped into the catching slot.

In an embodiment, an inclination angle of the second inclined guiding surface is in a range of 30 degrees to 45 degrees.

In the present embodiment, a plurality of second engaging assemblies are disposed along at least one of a X direction and a Y direction.

In an embodiment, the first connecting member includes an upper cover, a connecting frame and a lower cover connected to each other. The upper cover and the lower cover are connected to two opposite ends of the connecting frame, respectively. The second connecting member is a sheet metal layer that surrounds and covers at least part of a periphery of the connecting frame, to form the enclosed accommodating space together with the upper cover, the connecting frame and the lower cover.

In an embodiment, a thickness of the sheet metal layer is regarded as T1, and the thickness T1 of the sheet metal layer is greater than or equal to 1 mm.

In an embodiment, the first connecting member is defined as the lower cover. The second connecting member is defined as the intermediate housing. The intermediate housing includes at least one opening. The lower cover is mounted on a side, opposite to the opening, of the intermediate housing, so as to form the semi-enclosed accommodating space.

In an embodiment, the first connecting component is made of a rigid material, and the second connecting member is made of a flexible material.

In an embodiment, the rigid material is plastic, and the flexible material is selected from the group consisting of cloth, leather, and flexible plastic, and any combination thereof.

In an embodiment, the first connecting member is provided with at least one of a first limiting connecting mechanism and a second limiting connecting mechanism. The first limiting connecting mechanism of one stacking assembly or the second limiting connecting mechanism of one stacking assembly is capable of correspondingly fitting with the second limiting connecting mechanism of another adjacent stacking assembly or the first limiting connecting mechanism of another adjacent stacking assembly, such that the stacking assembly is capable of being stacked with and connected to another adjacent stacking assembly in sequence. Two adjacent stacking assemblies are at least restricted to move along a stacking direction.

In an embodiment, the first limiting connecting mechanism includes a first mating structure and a third mating structure. The first mating structure and the third mating structure are disposed on two positions of a top of the stacking assembly, respectively. The second limiting connecting mechanism includes a second mating structure and a fourth mating structure, and the second mating structure and the fourth mating structure are disposed on two positions of a bottom of the stacking assembly, respectively. The first limiting connecting mechanism and the second limiting connecting mechanism are engaging with each other to be in a locked state. When the first limiting connecting mechanism and the second limiting connecting mechanism are at the locked state, the second mating structure of one stacking assembly and the fourth mating structure of one stacking assembly are capable of correspondingly being in fit with the first mating structure of another adjacent stacking assembly and the third mating structure of another adjacent stacking assembly, respectively, under pressure of an upper stacking assembly, so as to restrict two adjacent stacking assemblies from moving along a X direction, a Y direction and a Z direction.

In an embodiment, the third mating structure is the same as the first mating structure and disposed opposite to the first mating structure. The fourth mating structure is the same as the second mating structure and disposed opposite to the second mating structure.

In an embodiment, the first mating structure includes a first elastic component and a first moving component. The first elastic component is capable of elastically acting on the first moving component. When two adjacent stacking assemblies are about to be stacked with each other, the first moving component is capable of moving on lower one of the two adjacent stacking assemblies under pressure of upper one of the two adjacent stacking assemblies. When the two adjacent stacking assemblies are stacked with each other, the first moving component is capable of being engaged with the second mating structure via an elastic force of the first elastic component, such that the first limiting connecting mechanism and the second limiting connecting mechanism are capable of being at the locked state under the pressure of upper one of the two adjacent stacking assemblies.

In an embodiment, the stacking assembly further includes a positioning assembly. When the positioning assembly is disposed at a positioning position, the first limiting connecting mechanism and the second limiting connecting mechanism are capable of being separated from each other to be in an unlocked state. The two adjacent stacking assemblies are separated from each other at the unlocked state.

In an embodiment, the first limiting connecting mechanism and the second limiting connecting mechanism are capable of being separated from each other to be in a reset state. Upper one of the two adjacent stacking assemblies is capable of being detached from lower one of the two adjacent stacking assemblies at the reset state, and the first mating structure is not under stress. A position of the first mating structure at the reset state is the same as a position of the first mating structure at the locked state.

In an embodiment, a stacking system is provided. A stacking system includes a plurality of stacking assemblies stacked and locked in sequence along a Z direction. Each of the plurality of stacking assemblies 1 is the stacking assembly of any one of claims 25 to 30.

Comparing with a related technology, in the present disclosure, the material of the first connecting member of the stacking assembly is different from that of the second connecting member of the stacking assembly, facilitating giving functional characteristics to different parts of the stacking assembly according to different material properties, or facilitate forming different parts of the stacking assembly and installing other mating members.

Details of one or more embodiments of the present disclosure are presented in the attached drawings and descriptions below. And other features, purposes, and advantages of the disclosure will become apparent from the description, drawings, and claims.

### BRIEF DESCRIPTION OF THE DRAWINGS

For a better description and illustration of embodiments and/or examples of those disclosures disclosed herein, reference may be made to one or more attached drawings. Additional details or examples used to describe the drawings should not be considered as limiting the scope of any of the disclosed disclosures, currently described embodiments and/or examples, and currently understood best modes of these disclosures.

FIG. 1 is a schematic diagram of a stacking assembly in a first embodiment of the present disclosure.

FIG. 2 is a schematic diagram of the stacking assembly in FIG. 1 in another view.

FIG. 3 is an enlarged schematic diagram of L portion in FIG. 1.

FIG. 4 is a schematic diagram of a stacking assembly in another embodiment of the present disclosure.

FIG. 5 is an enlarged schematic diagram of M portion in FIG. 4.

FIG. 6 is a schematic diagram of the stacking assembly in FIG. 4 in another view.

FIG. 7 is a schematic diagram of a bottom of the stacking assembly in FIG. 1.

FIG. 8 is an enlarged schematic diagram of N portion in FIG. 7.

FIG. 9 is a schematic diagram of the stacking assembly in another embodiment of the present disclosure.

FIG. 10 is a schematic diagram of the stacking assembly in FIG. 9 in another view.

FIG. 11 is a schematic diagram of the stacking assembly in another embodiment of the present disclosure.

FIG. 12 is a cross-sectional schematic view of the stacking assembly in FIG. 11 along F-F line.

FIG. 13 and FIG. 14 are enlarged schematic diagrams of P portion in FIG. 12.

FIG. 15 is a cross-sectional schematic view of the stacking assembly in FIG. 12 along G-G line.

FIG. 16 is a schematic diagram of a first stacking member of the stacking system in an embodiment of the present disclosure.

FIG. 17 is an enlarged schematic diagram of portion Ain FIG. 16 at a locked state.

FIG. 18 is an enlarged schematic diagram of portion A in FIG. 16 at an unlocked state.

FIG. 19 is a schematic diagram of a second stacking member of the stacking system in an embodiment of the present disclosure.

FIG. 20 is an enlarged schematic diagram of B portion in FIG. 19.

FIG. 21 is a schematic diagram of a stacking system in the present disclosure.

FIG. 22 is an enlarged schematic diagram of C portion of the stacking system in FIG. 21 at a locked state.

FIG. 23 is an enlarged schematic diagram of portion C of the stacking system in FIG. 21 at an unlocked state.

FIG. 24 is a schematic diagram of the first stacking member of the stacking system of FIG. 16 in another view.

FIG. 25 is a cross-sectional schematic view of the first stacking member along A-A line in FIG. 24.

FIG. 26 is an enlarged schematic diagram of D portion in FIG. 25 at a locked state.

FIG. 27 is an enlarged schematic diagram of D portion in FIG. 25 at an unlocked state.

FIG. 28 is a partial schematic diagram of the first stacking member in FIG. 16.

FIG. 29 is an enlarged schematic diagram of E portion in FIG. 28.

FIG. 30 is a schematic diagram of the stacking system in FIG. 16 in another view.

FIG. 31 is a cross-sectional schematic view of the first stacking member of the stacking system along B-B line in FIG. 30.

FIG. 32 is an enlarged schematic diagram of F portion in FIG. 31 at an unlocked state.

FIG. 33 is an enlarged schematic diagram of F portion in FIG. 31 at a locked state.

FIG. 34 is a cross-sectional schematic view of the first stacking member of the stacking system along C-C line in FIG. 30.

FIG. 35 is an enlarged schematic diagram of portion G in FIG. 34 at an unlocked state.

FIGS. 36 to 38 are schematic diagrams of a first moving component of the stacking assembly of FIG. 16 in different views.

FIG. 39 to FIG. 41 are schematic diagrams of a positioning assembly of the stacking assembly of FIG. 16 in different views.

FIG. 42 is an exploded schematic diagram of the first stacking member in FIG. 16.

FIG. 43 is a partial schematic diagram of the first stacking member in FIG. 42.

FIG. 44 is a partial schematic diagram of a stacking system in a second embodiment of the present disclosure.

FIG. 45 is a schematic diagram of the stacking assembly in FIG. 44 in another view.

FIG. 46 is a partial schematic diagram of a stacking system in a third embodiment of the present disclosure.

FIG. 47 to FIG. 50 are enlarged schematic diagrams of H portion when the stacking system in FIG. 46 is switched from a reset state to a locked state.

FIG. 51 is an enlarged schematic diagram of I portion in FIG. 50.

FIG. 52 is an enlarged schematic diagram of portion H in FIG. 46 at an unlocked state.

FIG. 53 is a partial schematic diagram of a stacking system in a fourth embodiment of the present disclosure.

FIG. 54 is a partial schematic diagram of a stacking assembly in a sixth embodiment of the present disclosure.

FIG. 55 is a schematic diagram of the stacking assembly in FIG. 54 in another view.

FIG. 56 is a cross-sectional schematic view of the stacking assembly in FIG. 55 along H-H line.

FIG. 57 is an enlarged schematic diagram of portion Q in FIG. 56.

FIG. 58 is a schematic diagram of a stacking system of a seventh embodiment in the present disclosure.

FIG. 59 is a schematic diagram of a stacking system of an eighth embodiment in the present disclosure.

FIG. 60 is a partial schematic diagram of a stacking system of a ninth embodiment in the present disclosure.

FIG. 61 is a schematic diagram of the stacking system in FIG. 60 in another view.

FIG. 62 is a cross-sectional schematic view of the stacking system along D-D line in FIG. 61.

FIG. 63 is an enlarged schematic diagram of J portion in FIG. 62.

FIG. 64 is a schematic diagram of the stacking system in FIG. 60 in another view.

FIG. 65 is an enlarged schematic diagram of a bottom of the second stacking member in FIG. 60.

FIG. 66 is a schematic diagram of a stacking system of a tenth embodiment in the present disclosure.

FIG. 67 is a first stacking member of the stacking system in FIG. 66.

FIG. 68 is a schematic diagram of the stacking system in FIG. 66 in another view.

FIG. 69 is a cross-sectional schematic view of the first stacking member of the stacking system along E-E line in FIG. 68.

FIG. 70 is an enlarged schematic diagram of K portion in FIG. 69.

FIG. 71 is a schematic diagram of a stacking system in an eleventh embodiment of the present disclosure.

FIG. 72 is a partial schematic diagram of the stacking system in FIG. 71.

Reference signs are as follows: 1 represents a stacking assembly; 1001 represents an accommodating space; 101 represents a first connecting member; 1011 represents an upper cover; 1012 represents a lower cover; 102 represents a second connecting member; 1021 represents an intermediate housing; 10210 represents a connecting plate; 10121 represents a bottom plate; 10122 represents a side plate; 1002 represents a fixing hole; 1013 represents a connecting frame; 1014 represents a bottom support; 1015 represents a supporting plate; 1022 represents a sheet metal layer; 1023 represents a bag; 1024 represents a card stand; 103 represents a sliding assembly; 1030 represents a sliding component; 10300 represents a sliding mating portion; 1031 represents a sliding rail; 1032 represents a slide groove; 10320 represents a stopping protrusion; 10321 represents a side notch; 10322 represents an end opening; 104 represents a first engaging assembly; 1041 represents a first engaging member; 10411 represents a mounting protrusion; 10412 represents a U-shape rod; 1042 represents a first mating portion; 10421 represents a first stopper; 10422 represents a second stopper; 4001 represents a first inclined guiding surface; 10423 represents an engaging gap; 105 represents a fixing member; 106 represents a second engaging assembly; 1061 represents a second engaging member; 10611 represents a catching leg; 10612 represents a limiting protrusion; 6001 represents a second inclined guiding surface; 1062 represents a second mating portion; 10620 represents a catching slot; 107 represents a first connecting component; 108 represents a drawer; 109 represents a key assembly; 10 represents a first stacking member; 11 represents a movable groove; 111 represents a first notch; 112 represents a second notch; 113 represents a first side wall; 114 represents a second side wall; 1141 represents a first limiting portion; 115 represents a bottom wall; 201 represents a bottom stand; 202 represents a push-pull portion; 2021 represents a button; 2022 represents a third elastic component; 2023 represents an engaging portion; 203 represents a rotatable portion; 204 represents a roll; 12 represents a fifth mating structure; 2001 represents a first limiting connecting mechanism; 20 represents a first mating structure; 21 represents a first elastic component; 22 represents a first moving component; 221 represents a base; 2211 represents a first assembly groove; 2212 represents a second limiting portion; 2213 represents a third limiting portion; 222 represents a first engaging portion; 2221 represents a first guiding bevel; 223 represents an auxiliary portion; 224 represents a rotatable base; 2241 represents a second assembly groove; 225 represents a slide groove; 30 represents a third mating structure; 40 represents a second stacking member; 41 represents a sixth mating structure; 5001 represents a second limiting connecting mechanism; 50 represents a second mating structure; 51 represents a second engaging portion; 511 represents an insertion groove; 512 represents a second guiding bevel; 60 represents a fourth mating structure; 70 represents a positioning mating portion; 71 represents a protrusion; 72 represents a catching leg; 721 represents a connecting portion; 722 represents a hook portion; 7221 represents a third guiding bevel; 7222 represents a fourth guiding bevel; 80 represents a positioning assembly; 81 represents a positioning member; 811 represents an inclined abutting surface; 812 represents an arc abutting surface; 813 represents a fourth limiting portion; 82 represents a second elastic component; 90 represents a mounting base; and 100 represents a stacking system.

### DETAILED DESCRIPTION

A stacking assembly 1 in the present disclosure is provided. The stacking assembly 1 is applied to a field of items storage including but not limited to store maintenance tools, children's toys, or other items.

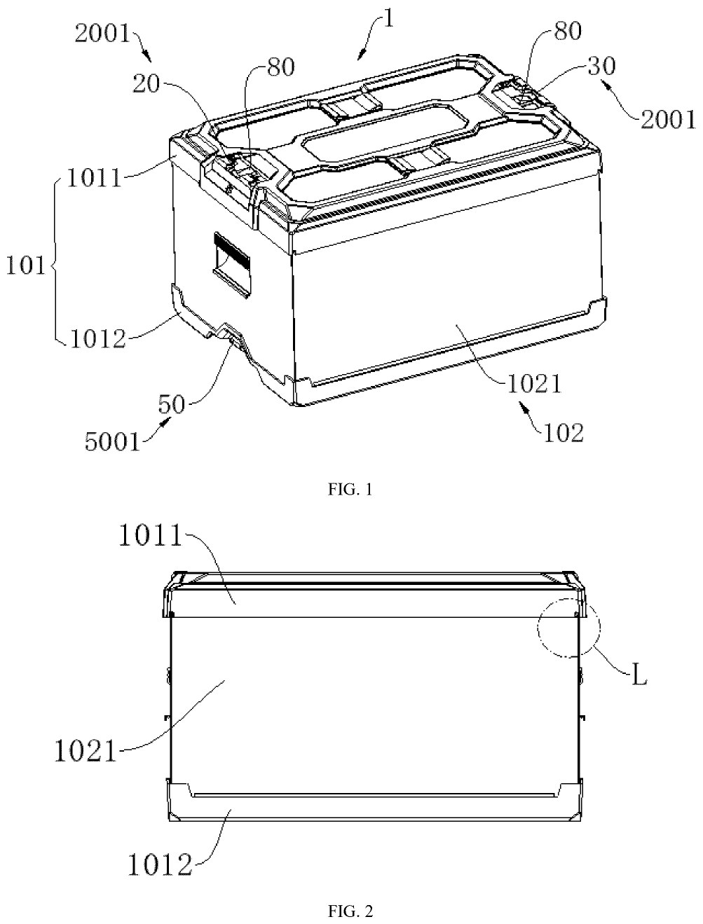

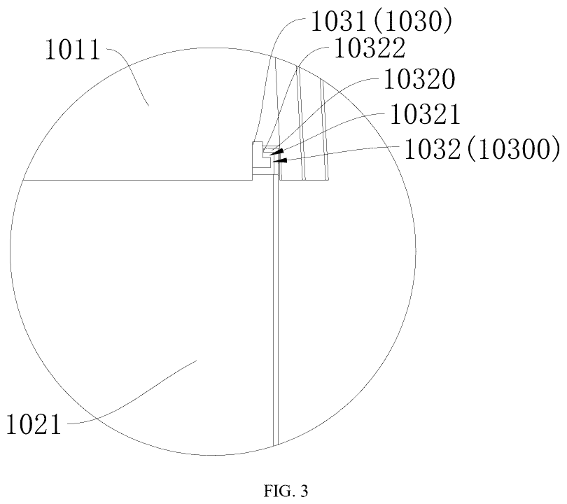

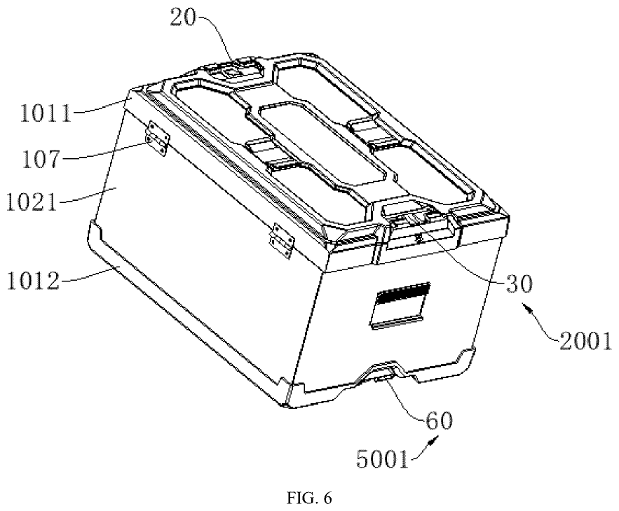

Referring to FIGS. 1 to 15, a stacking assembly 1 in the present disclosure is provided. The stacking assembly 1 has an accommodating space 1001. The stacking assembly 1 includes a first connecting member 101 and a second connecting member 102. The first connecting member 101 is configured to form at least one of an upper surface of the stacking assembly 1 and a lower surface of the stacking assembly 1. The second connecting member 102 is connected to the first connecting member 101 to form the accommodating space. A material of the first connecting member 101 is different from a material of the second connecting member 102.

By such arrangement, in the present disclosure, the material of the first connecting member 101 of the stacking assembly 1 is different from the material of the second connecting member 102 of the stacking assembly 1, such that different portions of the stacking assembly 1 may have at least one of different structural features and different functional characteristics.

In an embodiment of the present disclosure, a material of the first connecting member 101 is different from a material of the second connecting member 102.

For example, the first connecting member 101 is made of plastic; the second connecting member 102 is made of metal.

By such arrangement, the first connecting member 101 made of plastic may have a great plasticity, facilitating injecting and molding for different structures and shapes and changing a color and identification information. The second connecting 102 made of metal may ensure hardness and safety of the stacking assembly 1, so as to minimize a risk of damaging the second connecting member 102. The first connecting member 101 made of plastic is in fit with the second connecting 102 made of metal, facilitating enhancing practicality and aesthetics of the stacking assembly 1.

In other embodiments, the first connecting member 101 and the second connecting member 102 may be made of other rigid materials, as long as the material of the first connecting member 101 is different from that of the second connecting member 102, such that the first connecting member 101 and the second connecting member 102 can be molded to have different functional characteristics.

Furthermore, in the present disclosure, as long as the stacking assembly 1 has a position and a space for storage, the accommodating space formed by the first connecting member 101 and the second connecting member 102 may be enclosed or semi-enclosed.

Referring to FIGS. 1 to 3, in a stacking assembly 1 of the first embodiment of the present disclosure, the first connecting member 101 includes an upper cover 1011 and a lower cover 1012. The second connecting member 102 includes an intermediate housing 1021. The upper cover 1011 and the lower cover 1012 are mounted on two opposite sides of the intermediate housing 1021, respectively. An opening is defined on at least one side of the intermediate housing 1021. The upper cover 1011 is configured to cover the opening to form the enclosed accommodating space 1001.

The enclosed accommodating space 1001 refers to a plurality of sealing structures surround and form the accommodating space 1001. The plurality of sealing structures may be fixedly connected to each other, detachably connected to each other or movably connected to each other. In the present embodiment, the plurality of sealing structures include the upper cover 1011, the intermediate housing 1021 and the lower cover 1012.

In other embodiments, the intermediate housing 1021 includes a plurality of side walls, each of the plurality of side walls may be provided with an opening. For example, the opening disposed on a periphery of the intermediate housing 1021 may be mounted with a cabinet door (not shown) or a drawer 108, and so on. Furthermore, the intermediate housing 1021 may be further mounted with a key assembly 109, so as to lock the cabinet door or the drawer 108.

In the present disclosure, the stacking assembly 1 is provided with a square storage box having the sealed accommodating space 1001. In other embodiments, the stacking assembly 1 includes but not limited to a storage basket, a cart, and so on, which has the semi-enclosed accommodating space. In other embodiments, a shape of the stacking assembly includes but not limited to cuboid, cylinder, prism, and so on.

A plastic material is lightweight and has a strong malleability, facilitating forming the upper cover 1011 and the lower cover 1012 with different shapes by injecting respectively according to a material characteristic, so as to obtain different functions. Since the plastic is lightweight, the upper cover 1011 can be opened and closed more labor-saving and more conveniently.

The intermediate housing 1021 is made of metal, such that a main part of the stacking assembly 1 is hard to damage or deform, and the stacking assembly has a higher safety. When the stacking assembly 1 is used to accommodate a tool such as an electric drill, a hole puncher and so on, the intermediate housing 1021 is made of metal, so as to minimize a risk of damaging a side wall of the stacking assembly 1 due to collisions with sharp items such as drill bits, nails and so on.

In the present embodiment, the stacking assembly 1 is provided with a connecting mechanism, and the upper cover 1011 is flexibly connected to the intermediate housing 1021 via the connecting mechanism. By such arrangement, the upper cover 1011 may be removed as required, so as to open the opening and expose the accommodating space 1001, facilitating storing and retrieving the items in the accommodating space 1001.

Alternatively, in the present embodiment, the connecting mechanism includes a sliding assembly 103. The sliding assembly 103 includes a sliding component 1030 and a sliding mating portion 10300, and the sliding component 1030 is in fit with the sliding mating portion 10300. One of the sliding component 1030 and the sliding mating portion 10300 is disposed on the upper cover 1011, and the other one of the sliding component 1030 and the sliding mating portion 10300 is disposed on the intermediate housing 1021. The upper cover 1011 is capable of being slidably connected to the intermediate housing via cooperation between the sliding component 1030 and the sliding mating portion 10300. By such arrangement, the connecting mechanism is slidable, such that the structure of the connecting mechanism is simpler and the operation reduces labor, facilitating removing the upper cover 1011 to enclose or open the opening.

Alternatively, in the present embodiment, the upper cover 1011 may be capable of sliding and detaching from the intermediate housing 1021.

Alternatively, in the present embodiment, the sliding component 1030 includes a sliding rail 1031. The sliding mating portion 10300 includes a slide groove 1032 disposed on the intermediate housing 1021. In other embodiments, the sliding rail 1031 may be disposed on the intermediate housing 1021 or disposed on the upper cover 1011.

Referring to FIGS. 1 to 3, in the first embodiment of the present disclosure, the slide groove 1032 have a side notch 10321 and two opposite end openings 10322. The side notch is disposed towards a side of the stacking assembly 1. The two opposite end openings 10322 are configured to allow the sliding rail 1031 to slide from a side of the intermediate housing 1021 to the slide groove 1032. The sliding rail 1031 is in fit with the slide groove 1032 to prevent the upper cover 1011 from detaching from the intermediate housing 1021 along the Z direction. A protrusion direction of the sliding rail 1031 and an opening direction of the slide groove 1032 are both towards the side of the stacking assembly 1. The sliding rail 1031 is capable of sliding from at least one of the two end openings 10322 of two sides of the slide groove 1032, so as to limit the upper cover 1011 from detaching from the intermediate housing 1021 along a Z direction.

In the present embodiment, the sliding rail is configured as an L-shape protrusion protruding from a bottom of the upper cover 1011. The opening direction of the slide groove 1032 is towards an axis of the intermediate housing 1032.

In the present embodiment, the sliding component 1030 and the sliding mating portion 10300 are both provided with two groups. Two groups of the sliding components 1030 and the sliding mating portions 10300 are symmetrically disposed on two opposite sides of the stacking assembly 1. Two groups of the sliding components 1030 and the sliding mating portions 10300 can be in fit with each other to limit the upper cover from detaching from the intermediate housing 1021 along the Z direction and the X direction.

Alternatively, in the present embodiment, an inner wall of the slide groove 1032 is provided with a stopping protrusion 10320, and when a force applied on the upper cover body 1011 reaches to a preset value, the slider rail 1031 is capable of overcoming a resistance of the stopping protrusion 10320 and detaching from the slide groove 1032. The upper cover 1011 is capable of slidably detaching from the intermediate housing 1021. In other words, the stopping protrusion 10320 can restrict the upper cover 1011 from detaching from the intermediate housing 1021 along the sliding direction of the upper cover 1011 under no stress.

By such arrangement, the upper cover 1011 may be prevented from detaching from the intermediate housing 1021 when the upper cover 1011 is transported or bumped, so as to ensure a transporting stability of the upper cover 1011 and prevent the items in the accommodating space 1001 from losing or damaging.

In other embodiments, the upper cover 1011 may be rotatably connected to the intermediate housing via the connecting mechanism 1021.

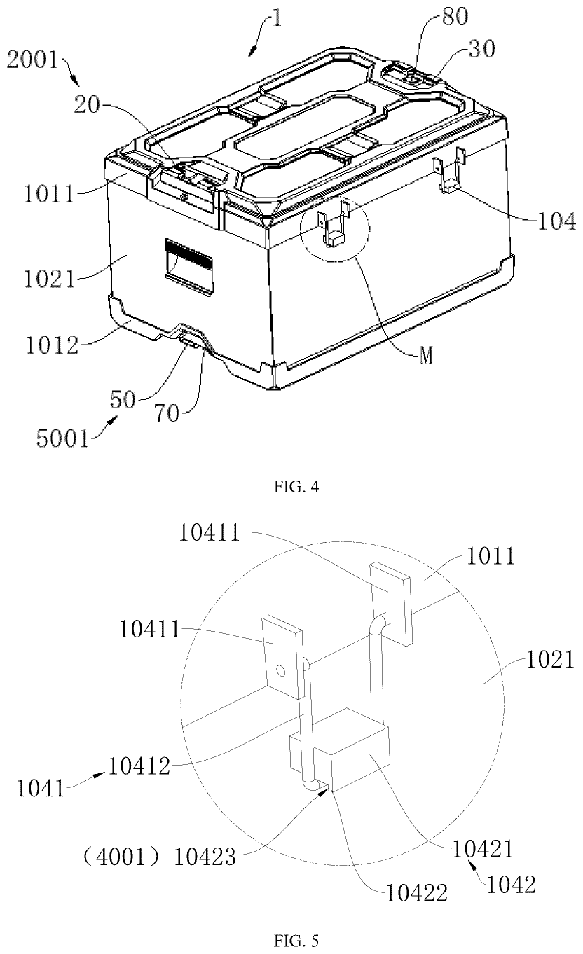

Referring to FIGS. 4 to 6, in an embodiment of the present disclosure, the connecting mechanism includes a first connecting component 107 and a first engaging assembly 104. A first side (not shown) of the upper cover 1011 is rotatably connected to the intermediate housing 1021 via the first connecting mechanism. A second side (not shown) of the upper cover 1011, opposite to the first side of the upper cover 1011, is snapped onto the intermediate housing 1021 via the first engaging assembly 104.

By such arrangement, the upper cover 1011 is capable of flipping relative to the intermediate housing 1021, so as to open or close the opening as required, which is conducive for users storing or retrieving the items in the accommodating space 1001.

In the present disclosure, the first connecting component 107 includes but not limited to a door hinge, a spring hinge, a damping hinge and so on. As long as a first side of the upper cover 1011 may be rotatably connected to the intermediate housing 1021.

Referring to FIG. 4 and FIG. 5, alternatively, in the present embodiment, the first engaging assembly 104 includes a first engaging member 1041 and a first mating portion 1042. The first engaging member 1041 is disposed on one of the upper cover 1011 and the intermediate housing 1021. The first mating portion 1042 is disposed on the other one of the upper cover 1011 and the intermediate housing 1021. The first engaging member 1041 and the first mating portion 1042 both have a mating state and a separating state. When the first engaging member 1041 and the first mating member 1042 are at the mating state, the upper cover 1011 is fixedly connected to the intermediate housing 1021, so as to close the opening. When the first engaging member and the first mating member 1042 are at the separating state, the upper cover 1011 is capable of flipping relative to the intermediate housing 1021, so as to expose the opening.

By such arrangement, the opening may be opened or closed as required, so as to expose or hide the accommodating space 1001, ensure the items to be easily stored and retrieved, and prevent the items from falling out from the accommodating space 1001 after putting the items into the accommodating space 1001.

Referring to FIG. 5, alternatively, in the present embodiment, the first mating portion 1042 includes a first stopper 10421 and a second stopper 10422. The first stopper 1042 protrudes from a periphery side wall of the intermediate housing 1021. The second stopper 10422 protrudes from a side, opposite to the upper cover 1011, of the first stopper 10421. An engaging gap 10423 is defined between the second stopper 10422 and the intermediate housing 1021. The first engaging member 1041 may be rotatably mounted on the upper cover 1011 and be capable of snapping into or detaching from the engaging gap 10423.

Referring to FIG. 5, alternatively, the first snapping assembly 104 further includes two mounting protrusions 10411. The first engaging member 104 is configured as a U-shaped rod which is rotatably mounted between the two mounting protrusions. The U-shaped rod can be rotated to engage with the first mating portion 1042 under the external force. This is, the bottom of the U-shaped rod 10412 may be rotatably snapped into the engaging gap 10423.

Alternatively, in the present embodiment, in order to facilitate the U-shaped rod 10412 detaching from the engaging gap 10423, a side of the second stopper 10422 towards the intermediate housing 1021 is provided with a first inclined guiding surface 4001. An inclined direction of the first inclined guiding surface 4001 is downward and towards a side of the intermediate housing 1021, so as to play a guiding role when the first engaging member 1041 is detached from the engaging gap 10423.

Alternatively, in the present embodiment, the first stopper 10421 is integrated with the second stopper 10422.

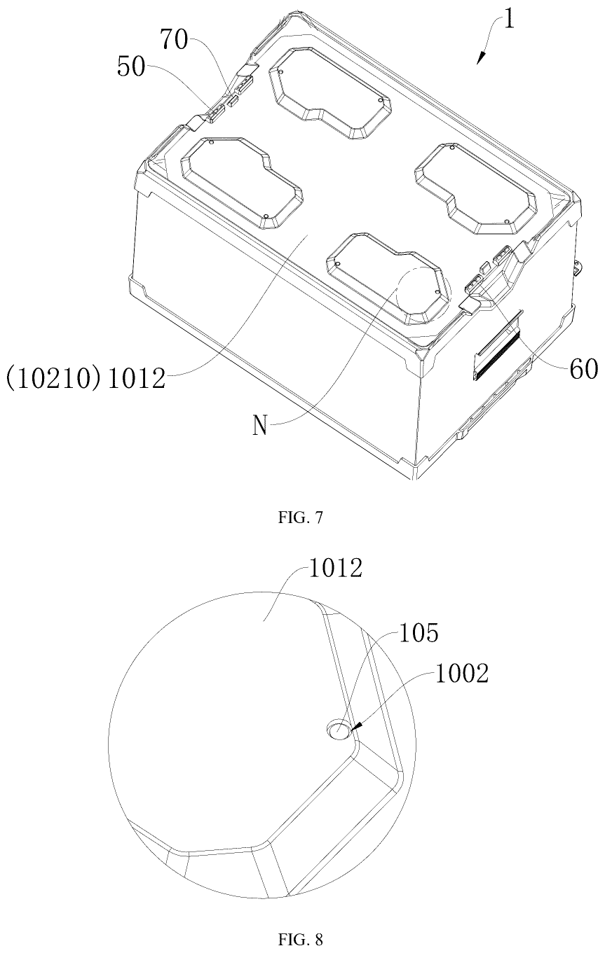

Referring to FIGS. 7 and 8, alternatively, in the present embodiment, the stacking assembly 1 further includes a fixing member 105. The lower cover 1012 is connected to a bottom of the intermediate housing 1021 via the fixing member 105.

In the present embodiment, a side of the intermediate housing 1021 opposite to the upper cover 1011 is provided with a connecting plate 10210. The lower cover 1012 is connected to the connecting plate 10210 via the fixing member 105. The connecting plate 10210 may be an overall plate or a hollow plate, as long as the connecting plate 10210 may provide a connecting position.

Referring to FIG. 8, alternatively, the lower cover 1012 is provided with a fixing hole 1002. The fixing hole 1002 is regarded as a layer hole. When the fixing member 105, such as a rivet and so on, is connected to the intermediate housing 1021 via the fixing hole 1002, the fixing member 105 can be hided in the layer hole, so as to prevent the fixing member 105 from protruding from a surface of the lower cover 1012, thereby affecting safety or stability of the stacking assembly 1. The number of the fixing member 105 is not limited.

Alternatively, in the present disclosure, the number of fixing member 105 is multiple. Alternatively, a plurality of fixing members 105 are arranged diagonally in pairs.

The fixing member 105 includes but not limited to a rivet or a bolt and so on, as long as the lower cover 1012 can be stably and firmly connected to the intermediate housing 1021.

When the lower cover 1012 is disposed on the intermediate housing 1021, a side of the intermediate housing 1021 corresponding to the lower cover 1012 may be an open structure, an enclosed structure, or a semi-enclosed structure.

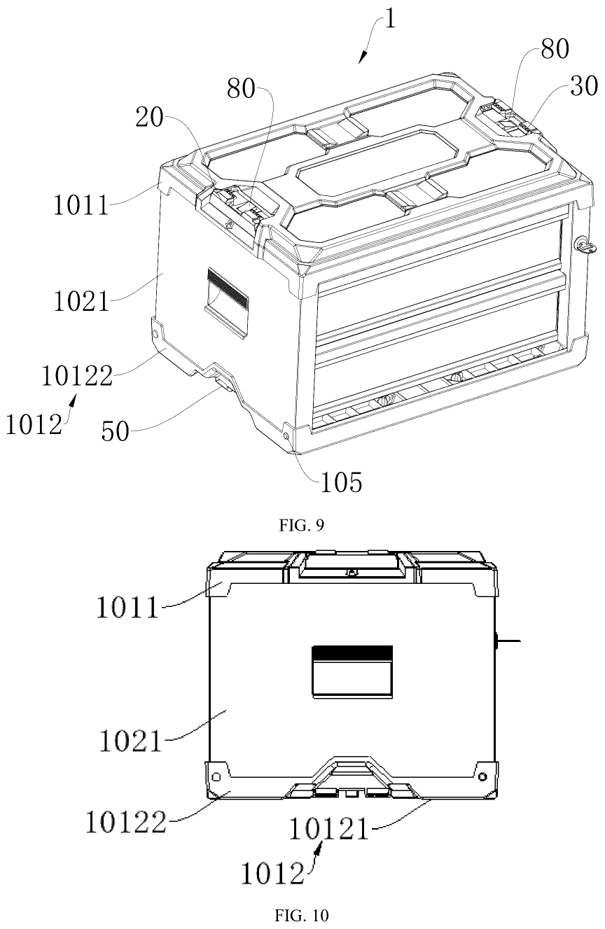

Referring to FIGS. 9 and 10, in other embodiments, the lower cover 1012 includes a bottom plate 10121 and a side plate 10122 disposed on a periphery of the bottom plate 10121. A side wall of the intermediate housing 1021 is connected to a side plate 10122 of the lower cover 1012 via the fixing member 105.

Alternatively, the stacking assembly 1 is provided with at least two groups of fixing members, which is opposite to each other along the X direction and the Y direction. Each of the two groups of fixing members includes two fixing members 105. The fixing member 105 includes but not limited to a rivet or a bolt and so on.

Alternatively, in the present embodiment, the fixing member 105 is defined as a rivet. Compared with the bolt, the rivet can ensure a whole wall thickness of the stacking assembly 1, the side wall of the intermediate housing 1021 is connected to the side plate 10122 of the lower cover 1012 via the rivet, so as to maximize utilization of the accommodating space 1001 inside the stacking assembly 1, thereby reducing a space configured to fit with the bolt.

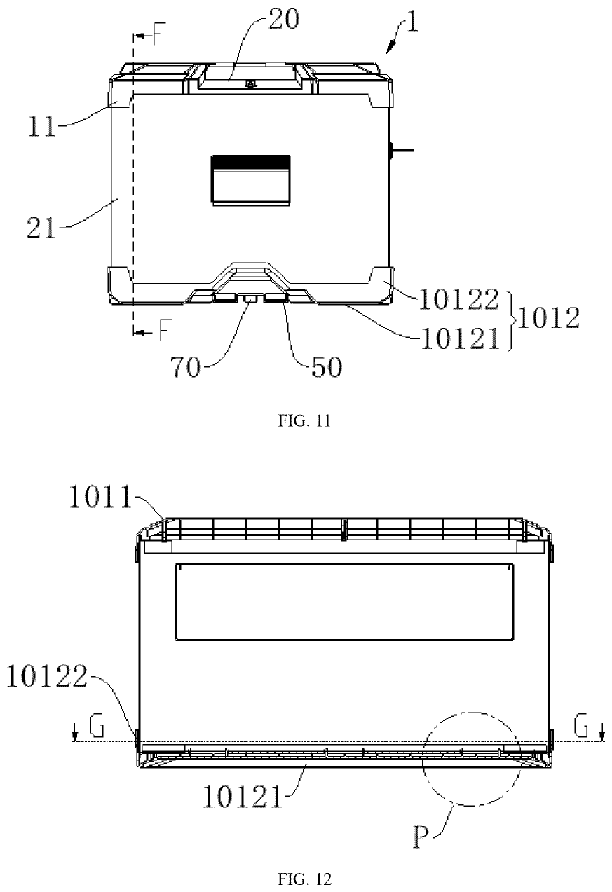

Referring to FIGS. 11 to 15, it can be understood that the lower cover 1012 may be connected to the intermediate housing 1021 via a way of engagement.

The stacking assembly 1 further includes a second engaging assembly 106. The second engaging assembly 106 includes a second engaging member 1061 and a second mating portion 1062. One of the second engaging member 1061 and the second mating portion 1062 is disposed on a bottom of the intermediate housing 1021, and the other one of the second engaging member 1061 and the second mating portion 1062 is disposed on the lower cover 1012. The second engaging member 1061 is in fit with the second mating portion 1062, such that the lower cover 1012 is connected to the bottom of the intermediate housing 1021. By such arrangement, the way of engagement is easy and convenient, the lower cover 1012 can be firmly connected to the intermediate housing 1021 without an additional tool.

Referring to FIGS. 11 to 13, alternatively, in an embodiment of the present disclosure, the second engaging member 1061 protrudes from the lower cover 1012. The second engaging member 1061 each includes two catching legs 10611 disposed at interval. One side, away from each other, of each of the two catching legs 10611 is provided with a limiting protrusion 10612.

The second mating portion 1062 includes a catching slot 10620 disposed on the intermediate housing 1021. The two catching legs 10611 are capable of deforming and extending to the same catching slot 10620 or to two catching slots 10620, respectively, via an external force. Two limiting protrusions 10612 are snapped into the same catching slot 10620 or into the two catching slots 10620, respectively, after removing the external force.

The two opposite limiting protrusions 10612 can be in fit with the catching slot 10620 to limit the lower cover 1012 from detaching from the intermediate housing 1021 along the Z direction. The two catching legs can be in fit with each other to limit the lower cover 1012 from detaching from the intermediate housing 1021 along the X direction and the Y direction.

Alternatively, one side, opposite to each other, of each of the two limiting protrusions 10612 is provided with a second inclined guiding surface 6001. The second inclined guiding surface 6001 is configured to play a guiding role when the second engaging member 1061 is snapped into the catching slot 10620. The second engaging member 1061 may deform to be snapped onto the catching slot 10620 by vertical pressure, and after the second engaging member 1061 being snapped, a side, away from the upper cover 1011, of the limiting protrusion 10612 is snapped on an edge of the catching slot 10620.

Alternatively, an inclined angle of the second inclined guiding surface 6001 is in a range of 30 degrees to 45 degrees, which includes 30 degrees and 45 degrees. As the inclined angle of the second inclined guiding surface 6001 does not affect connecting stability between the lower cover 1012 and the intermediate housing 1021, in other embodiments, the inclined angle of the second inclined guiding surface 6001 may less than 30 degrees or greater than 45 degrees.

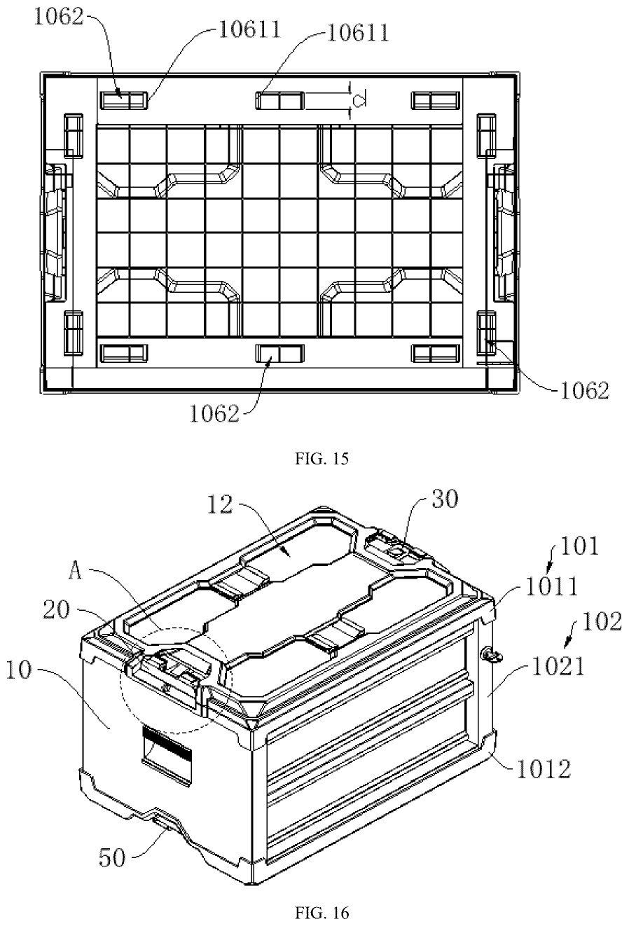

Referring to FIGS. 14 and 15, in order to facilitate snapping the second engaging member 1061 into the catching slot 10620 and ensure stability between the second engaging member 1061 and the catching slot 10620 after being snapped, in the present embodiment, a width of the catching leg 10611 is regarded as a, a height of the limiting protrusion 10612 is regarded as b a width of the limiting protrusion 10612 is regarded as c, and a width of the catching slot 10620 is regarded as d. Alternatively, the width a is greater than or equal to 2 mm, the height b is greater than or equal to 3 mm, the width c is greater than or equal to 2 mm, and the width d is greater than or equal to 2 mm, such that the inclined angle of the second inclined guiding surface 6001 is in the range of 30 degrees to 45 degrees.

Alternatively, a plurality of second engaging assemblies 106 are disposed along at least one of the X direction of the stacking assembly 1 and the Y direction of the stacking assembly 1. In other words, the number of the second engaging assembly 106 can be one or more along both the X direction and the Y direction. Alternatively, referring to FIG. 15, in the present embodiment, the plurality of second engaging assemblies 106 are disposed at interval in a group of three along the X direction, and the plurality of second engaging assemblies 106 are disposed at interval in a group of two along the Y direction.

Furthermore, in the present disclosure, the stacking assembly 1 is provided with at least one of a first limiting connecting mechanism 2001 and a second limiting connecting mechanism 5001. The first limiting connecting mechanism 2001 of one stacking assembly 1 or the second limiting connecting mechanism 5001 of one stacking assembly 1 is capable of correspondingly fitting with the second limiting connecting mechanism 5001 of another adjacent stacking assembly 1 or the first limiting connecting mechanism 2001 of another adjacent stacking assembly 1, such that the stacking assembly 1 is capable of being stacked with and connected to another adjacent stacking assembly 1 in sequence. Two adjacent stacking assemblies 1 are at least restricted from moving along a stacking direction.

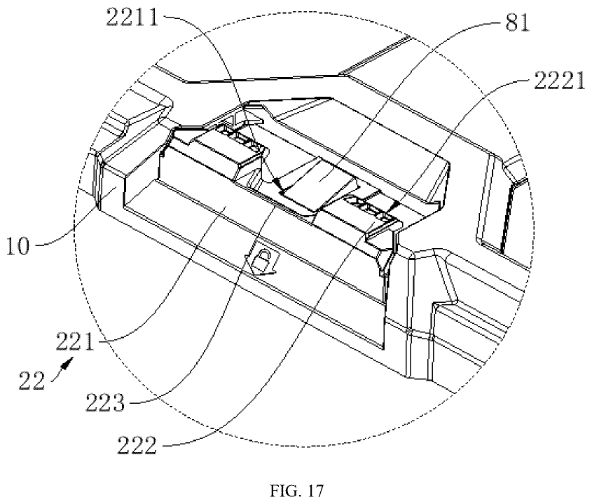

Referring to FIGS. 1 to 21, the first connecting member 101 and the second connecting member 102 have different structures and different connecting ways, the first connecting member 101 and the second connecting member 102 can be correspondingly provided with the first limiting connecting mechanism 2001 and the second limiting connecting mechanism 5001, respectively, such that a plurality of stacking assemblies 1 in different embodiments or a plurality of stacking assemblies 1 in the same embodiments can be stacked and connected to each other, facilitating transporting and storing.

In the present disclosure, the plurality of stacking assemblies 1 may be stacked with each other and locked to form a stacking system 100 via the first limiting connecting mechanism 2001 and the second limiting connecting mechanism 5001, facilitating storing and transporting the plurality of stacking assemblies 1.

In the present disclosure, the first connecting member 101 is made of plastic, such that the upper cover 1011 and the lower cover 1012 disposed on an upper side of the stacking assembly 1 and a lower side of the stacking assembly 1, respectively, are easy to be stacked and locked. Therefore, the stacking assembly 1 has a simpler overall manufacturing process, which is easier to be installed, stacked and stored, saving transportation costs.

In the present disclosure, the first limiting connecting mechanism 2001 includes a first mating structure 20 and a third mating structure 30. The first mating structure 20 and the third mating structure 30 are disposed on two positions of a top of the stacking assembly 1, respectively. The second limiting connecting mechanism 5001 includes a second mating structure 50 and a fourth mating structure 60. The second mating structure 50 and the fourth mating structure 60 are disposed on two positions of a bottom of the stacking assembly 1, respectively. The first limiting connecting mechanism 2001 and the second limiting connecting mechanism 5001 are in fit with each other to be in a locked state. When the first limiting connecting mechanism 2001 and the second limiting connecting mechanism 5001 are at the locked state, the second mating structure 50 of one stacking assembly 1 and the fourth mating structure 60 of one stacking assembly 1 are capable of being in fit with the first mating structure 20 of another adjacent stacking assembly 1 and the third mating structure 30 of another adjacent stacking assembly 1, respectively, under pressure of an upper stacking assembly 1, so as to restrict two adjacent stacking assemblies 1 from moving along the X direction, the Y direction and the Z direction. In a portion, the two adjacent stacking assemblies 1 are in fit with and restricted to each other via the first mating structure 20 and the second mating structure 50, and in another portion, the two adjacent stacking assemblies 1 are in fit with and restricted to each other via the third mating structure 30 and the fourth mating structure 60. When the first mating structure 20 is in fit with the second mating structure 50 and the third mating structure 30 is in fit with the fourth mating structure 60, a relative moving of the two adjacent stacking assemblies 1 is limited along the X direction, the Y direction and the Z direction.

By such arrangement, when the plurality of stacking assemblies 1 are stacked, placed or transported, it only requires to directly transport and dispose one of the plurality of stacking assemblies 1 on another of the plurality of stacking assemblies 1, such that the plurality of stacking assemblies 1 may form a locking state via an upper one of the plurality of stacking assemblies 1, thereby reducing complexity of a locking operation, and effectively improving operation efficiency and convenience for stacking and locking the plurality of stacking assemblies 1.

A top of the stacking assembly 1 refers to a side of the upper cover 1011 away from the lower cover 1012. A bottom of the stacking assembly 1 refers to a side of the lower cover 1012 away from the upper cover 1011.

The pressure of the upper one of the two adjacent stacking assemblies 1 can only include gravity formed by a weight of the upper one of the two adjacent stacking assemblies 1, or can include the gravity formed by the weight of the upper one of the two adjacent stacking assemblies 1, gravity formed by the items disposed in the upper one of the two adjacent stacking assemblies 1, an additional external force applied to the upper one of the two adjacent stacking assemblies 1 and so on.

In the present disclosure, the second connecting member 102 is made of metal, such that the stacking assembly 1 have relative high hardness, which is hard to damage, density and weight of the metal can facilitate the upper one of the two adjacent stacking assemblies 1 with and locking with and the lower one of the two adjacent stacking assemblies 1 by the weight of the upper one of the two adjacent stacking assemblies 1, the two adjacent stacking assemblies 1 can be stably stacked and connected to each other without the additional external force, thereby effectively reducing or avoiding a risk of separation during transportation. Comparing with the stacking locking structure in a related technology, in the present disclosure, a stacking and locking structure of the stacking assembly 1 is simple, a stacking process between the plurality of stacking assemblies 1 is fast, reliable, and operation steps of the stacking process are fewer, thereby effectively improving stacking efficiency.

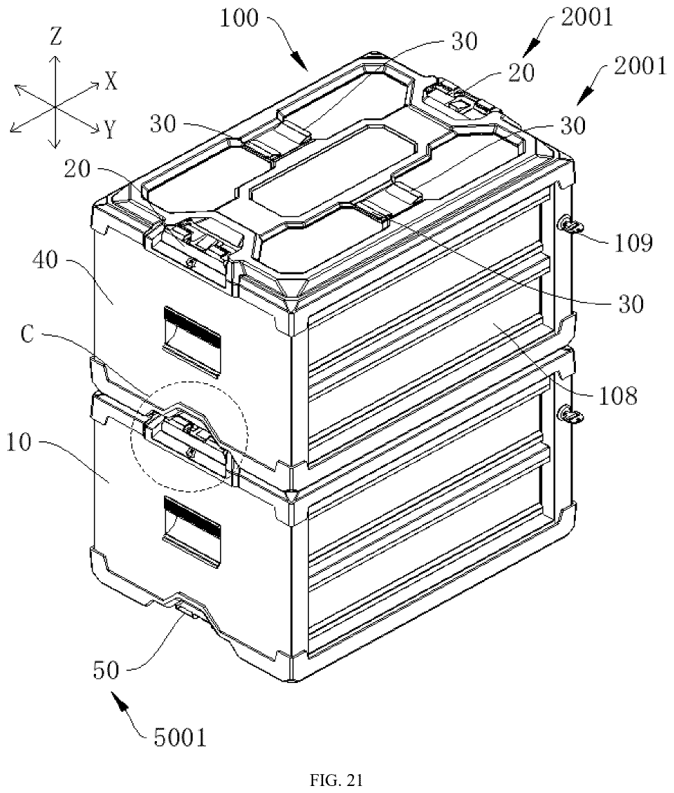

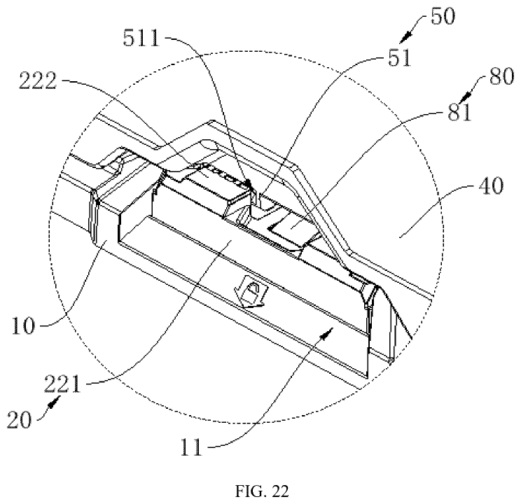

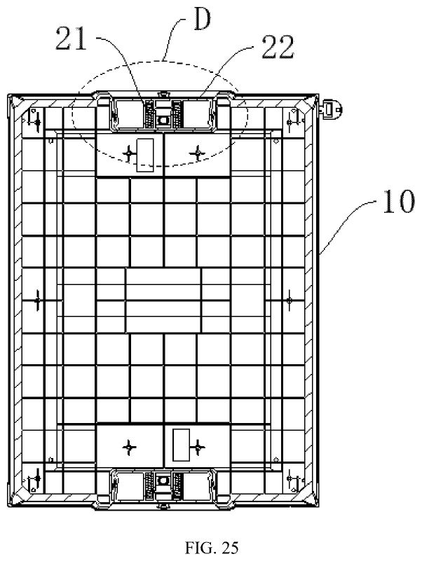

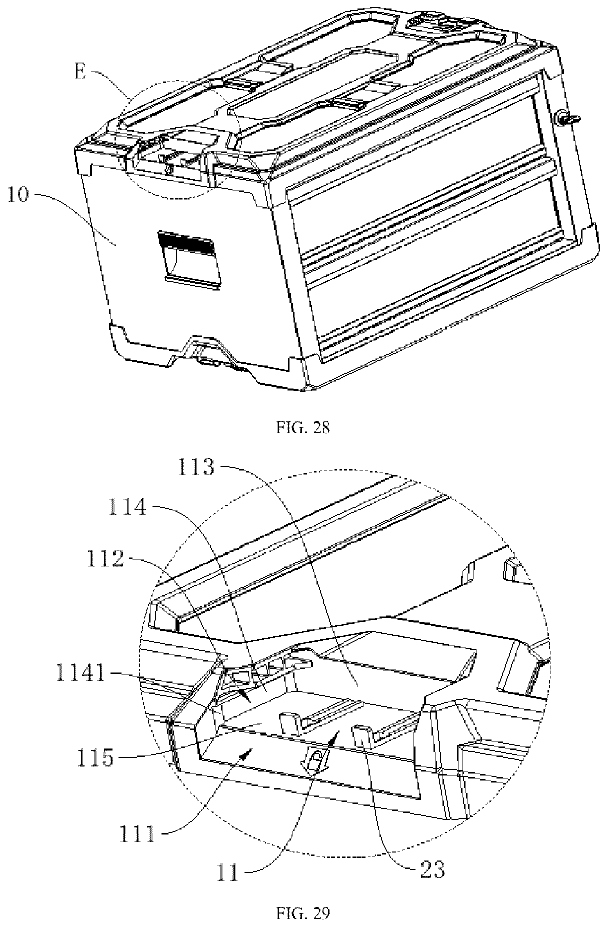

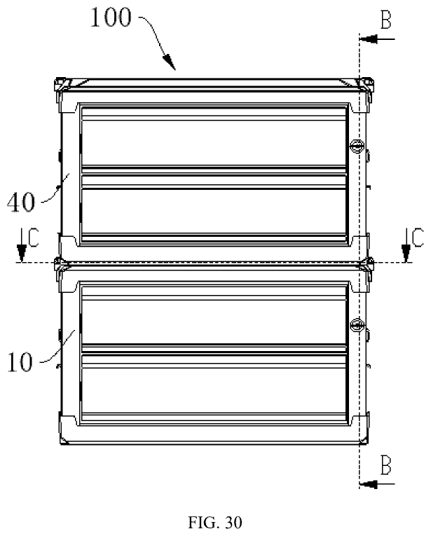

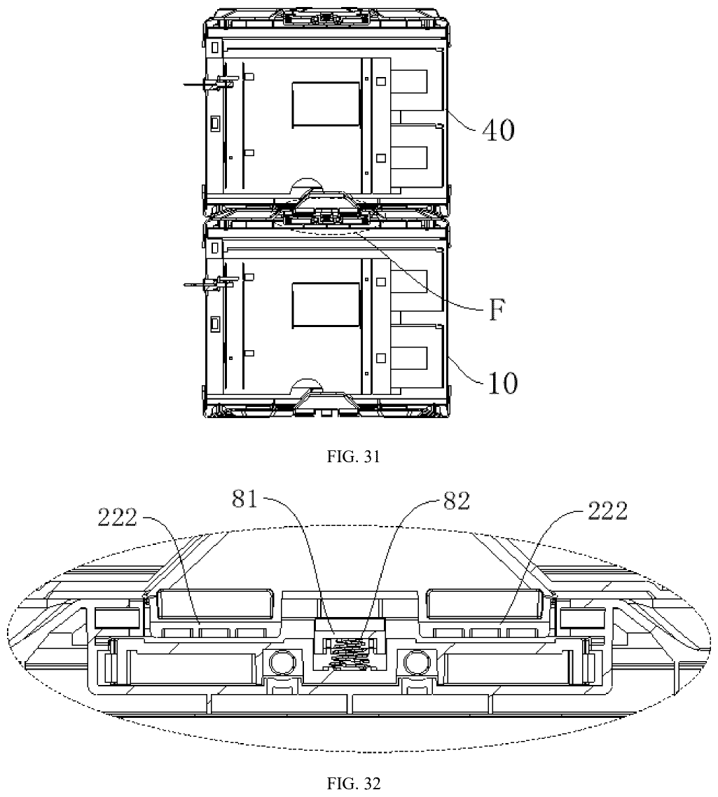

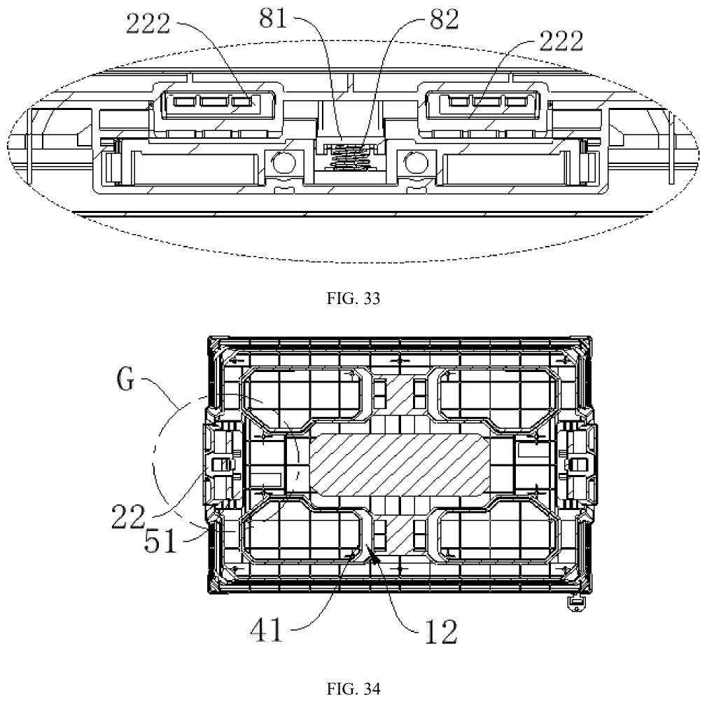

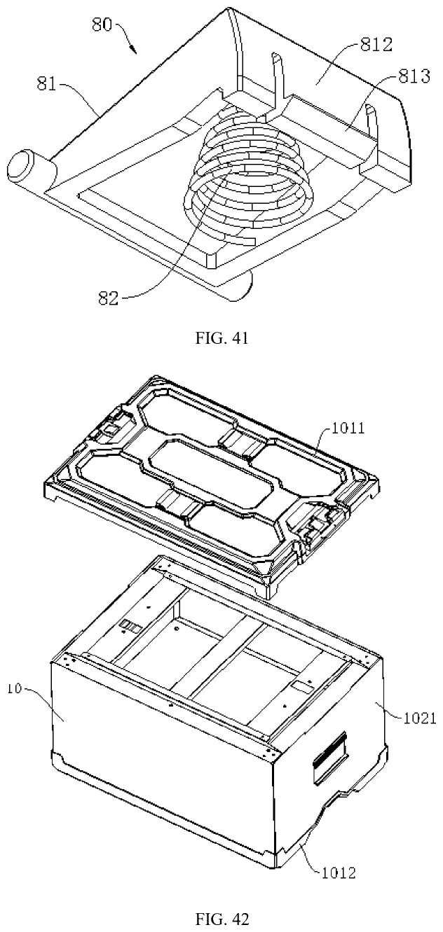

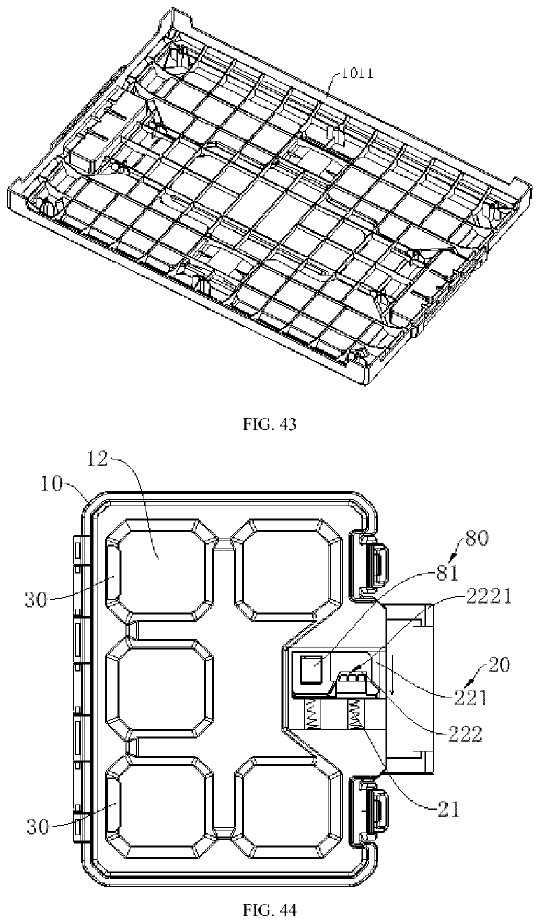

Referring to FIGS. 1 to 15 and FIGS. 16 to 43, for example, the stacking assembly 1 is a square body. The X direction, the Y direction, and the Z direction correspond to a length direction of the stacking assembly 1, a width direction of the stacking assembly 1, and a height direction of the stacking assembly 1, respectively. The height direction is regarded as a stacking direction that the plurality of stacking assemblies 1 can be stacked with each other in sequence. In other embodiments, when a shape of the stacking assembly 1 is cylindrical, polygonal or other shapes, the X direction, the Y direction, and the Z direction may be defined according to a specific shape of the stacking assembly 1.

In an embodiment of the present disclosure, two sides of the top of the stacking assembly 1 are provided with at least one group of the first mating structure 20 and the third mating structure 30 along the X direction. Alternatively, two sides of the bottom of the stacking assembly 1 are provided with at least one group of the second mating structure 50 and the fourth mating structure 60 along the X direction. Alternatively, two sides of the top of the stacking assembly 1 are provided with at least one group of the first mating structure 20 and the third mating structure 30 along the Y direction. Alternatively, two sides of the bottom of the stacking assembly 1 are provided with at least one group of the second mating structure 50 and the fourth mating structure 60 along the Y direction. The top of one stacking assembly 1 and the bottom of one stacking assemblies 1 can both be provided with one or more first limiting connecting mechanism 2001 and one or more second limiting connecting mechanism 5001, respectively, such that at least one of the top of one stacking assembly 1 and the bottom of one stacking assembly 1 can be stacked with and locked with another stacking assembly 1.

The first limiting connecting mechanism 2001 each can include one or more first mating structure 20 and one or more third mating structure 30. The first limiting connecting mechanism 2001 each is configured to position the first stacking assembly 1. The lower one of the two adjacent stacking assembly 1 may position the upper one of the two adjacent stacking assembly 1 via one or more first mating structure 20 and one or more third mating structure 30, the number and the position of the first mating structure 20 and the number and the position of the third mating structure 30 are required to position the upper one of the two adjacent stacking assemblies 1 may be selected as required, such that the top of the lower one of the two adjacent stacking assemblies 1 can fix other stacking assemblies 1 of at least one of different sizes and different numbers.

Alternatively, the third mating structure 30 is the same as the first mating structure 20 and disposed opposite to the first mating structure 20. The fourth mating structure 60 is the same as the second mating structure 50 and disposed opposite to the second mating structure 50.

Furthermore, the third mating structure 30 and the first mating structure 20 are the same and symmetrically disposed along an axis of the stacking assembly 1. The fourth mating structure 60 and the second mating structure 50 are the same as and symmetrically disposed along the axis of the stacking assembly 1.

Moreover, the third mating structure 30 and the first mating structure 20 are the same and symmetrically disposed along the axis of the stacking assembly 1. The fourth mating structure 60 and the second mating structure 50 are the same as and symmetrically disposed along the axis of the stacking assembly 1. By such arrangement, it is conducive to operating.

In an embodiment of the present disclosure, the third mating structure 30 and the first mating structure 20 are the same and symmetrically disposed on two opposite sides of the stacking assembly 1 along the axis of the stacking assembly 1. The fourth mating structure 60 and the second mating structure 50 are the same as and symmetrically disposed on two opposite sides of the stacking assembly 1 along the axis of the stacking assembly 1. In other embodiments, the third mating structure 30 and the first mating structure 20 can be disposed relative to other axes of the stacking assembly 1. Relative arrangement between the third mating structure 30 and the first mating structure 20 includes but not limited to an axisymmetric arrangement. The relative arrangement between the third mating structure 30 and the first mating structure 20 can include a diagonal arrangement, in which the third mating structure 30 and the first mating structure 20 can be disposed on two sides of the axis of the stacking assembly 1.

Moreover, in an embodiment of the present disclosure, the first mating structure 20 and the third mating structure 30 can be disposed on a same height plane or different height planes. Two positions of the stacking assembly 1 can have different heights, in which the first mating structure 20 and the third mating structure 30 can be disposed on the two positions of the stacking assembly 1, respectively. Correspondingly, the second mating structure 50 and the fourth mating structure 60 fitting with the first mating structure 20 and the third mating structure 30, respectively, also require to have different heights.

In other embodiments, the first mating structure 20 can be different from the third mating structure 30. As long as the first mating structure 20 can be in fit with the second mating structure 50, and the third mating structure 30 can be in fit with the fourth mating structure 60 to limit the two adjacent stacking assemblies 1 from moving.

In other embodiments, when a top of the stacking assembly 1 is provided with a plurality of third mating structure 30, a part of the third mating structure 30 may be the same as the first mating structure 20, a part of the third mating structure 30 can be different from the first mating structure 20. The position of the third mating structure 30 is determined by a size of the upper one of the two adjacent stacking assemblies 1.

Referring to FIGS. 16 to 41, in an embodiment of the present embodiment, the first mating structure 20 includes a first elastic component 21 and a first moving component 22. The first elastic component 21 is capable of elastically acting on the first moving component 22. When the two adjacent stacking assemblies 1 are about to be stacked with each other, the first moving component 22 is capable of moving on lower one of the two adjacent stacking assemblies 1 under pressure of the upper one of the two adjacent stacking assemblies 1. When the two adjacent stacking assemblies 1 are stacked with each other, the first moving component 22 is capable of being engaged with the second mating structure 50 via an elastic force of the first elastic component 21, such that the first limiting connecting mechanism 2001 and the second limiting connecting mechanism 5001 are capable of being at the locked state under the pressure of the upper one of the two adjacent stacking assemblies 1.

By such arrangement, during a process of stacking, it only requires to be disposed one stacking assembly 1 on another stacking assembly 1 in sequence, such that a locked state can be automatically formed by pressure generated from at least one of the weight of the upper one of the two adjacent stacking assemblies 1, a weight of the item inside the stacking assembly 1, and the external force applied to the upper one of two adjacent stacking assemblies 1 by external environment, thereby reducing complexity of a locked operation and effectively improving working efficiency and convenience for stacking and positioning the plurality of stacking assembly 1.

The first moving component 22 can slide, rotate or move by other ways in the stacking assembly 1. The first moving component 22 can be slidably connected to the stacking assembly 1 or rotatably connected to the stacking assembly 1, as long as the first moving component 22 does not affect snap-cooperation between the first mating structure 20 and the second mating structure 50.

Referring to FIGS. 1 and 16 to 41, in an embodiment of the present embodiment, the stacking assembly 1 further includes a positioning assembly 80. When the positioning assembly 80 is disposed at a positioning position, the first limiting connecting mechanism 2001 and the second limiting connecting mechanism 5001 can be separated from each other to form an unlocked state. When the first limiting connecting mechanism 2001 and the second limiting connecting mechanism 5001 are at the unlocked state, the at least two adjacent stacking assemblies 1 can be separated from each other.

Referring to FIGS. 16 to 41, in an embodiment of the present embodiment, the positioning assembly 80 is disposed at the first mating structure 20. The first mating structure 20 can drive the positioning assembly 80 to move to the positioning position under the external force, such that the first limiting connecting mechanism 2001 and the second limiting connecting mechanism 5001 can be switched from the locked state to the unlocked state. By such arrangement, the positioning assembly 80 is disposed on the first mating structure 20, such that the positioning assembly 80 and the first mating structure 20 can maintain synchronization, facilitating operating and quickly forming the unlocked state. In other embodiments, the positioning assembly 80 may be disposed on other positions of the stacking assembly 1, as long as the first limiting connecting mechanism 2001 and the second limiting connecting mechanism 5001 can be switched from the locked state to the unlocked state.

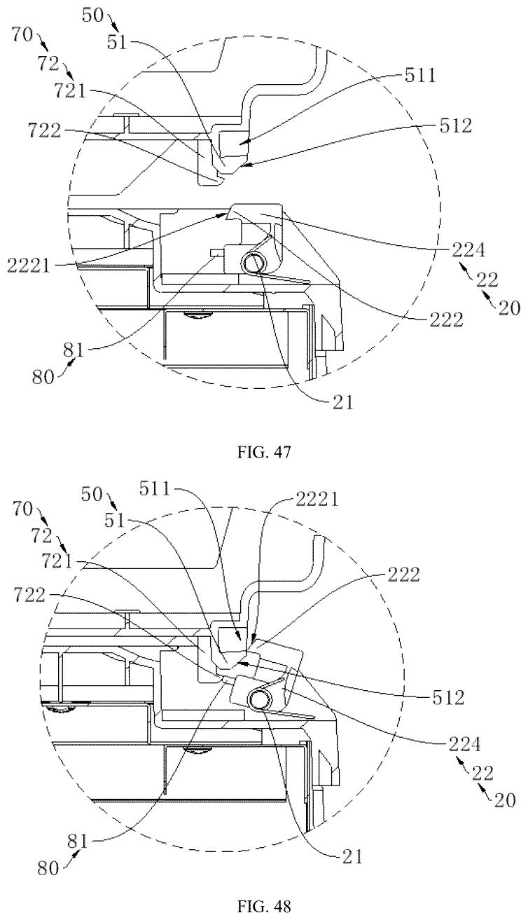

Referring to FIGS. 47 and 50, in an embodiment of the present disclosure, the first limiting connecting mechanism 2001 and the second limiting connecting mechanism 5001 further have a reset state when the first limiting connecting mechanism 2001 is separated from the second limiting connecting mechanism 5001. When the first limiting connecting mechanism 2001 and the second limiting connecting mechanism 5001 are at the reset state, the upper one of the two adjacent stacking assemblies 1 is detached from the lower one of the two adjacent stacking assemblies 1. When the first mating structure 20 is not under stress, a position of the first mating structure 20 at the reset state is the same as a position of the first mating structure 20 at the locked state.

In other embodiments, a position of the first mating structure 20 at the locked state may be different from a position of the first mating structure 20 at the reset state, as long as the first limiting connecting mechanism 2001 can be in fit with the second limiting connecting mechanism 5001 to restrict the two adjacent stacking assemblies 1 from moving along the X direction, the Y direction and the Z direction, in which the two adjacent stacking assemblies 1 are stacked with and locked with each other.

In order to facilitate understanding cooperation between the first limiting connecting mechanism 2001 and the second limiting connecting mechanism 5001, for example, two or more stacking assembles 1 are stacked to illustrate a part of implementable structures and processes of the first limiting connecting mechanism 2001, the second limiting connecting mechanism 5001, and the positioning assembly 80. In the following embodiments, the lower one of the two adjacent stacking assemblies 1 is named as a first stacking assembly 10, and the upper one of the two adjacent stacking assemblies 1 is named as the second stacking assembly 40. In the following embodiments, both the first stacking assembly 10 and the second stacking assembly 40 are essentially the stacking assembly 1. Specific implements that the first connecting member 101 of the stacking assembly 1 and the second connecting member 102 of the stacking assembly 1 form the accommodating space 1001 includes but not limited to above four embodiments.

Referring to FIGS. 16 to 23 and FIGS. 24 to 40, the first stacking assembly 10 and the second stacking assembly 40 are both the same square storage box with a certain size. The X direction, the Y direction and the Z direction correspond to a length direction of the first stacking assembly 10, a width direction of the first stacking assembly 10 and a height direction of the first stacking assembly 10.

In other embodiments, when coordinate system in the X direction, Y direction, and Z direction are determined, a corresponding relationship between the length direction of the stacking assembly 1, the width direction of the stacking assembly 1 and the height direction of the stacking assembly 1 and the X direction, the Y direction and the Z direction corresponds to a length of the stacking assembly 1, a width of the stacking assembly, a height of the stacking assembly 1 and an arrangement direction of the stacking assembly 1, which corresponds as required. For example, in the same coordinate system in the X direction, Y direction, and Z direction, the length direction of the first stacking assembly 10 corresponds to the X direction, the width direction of the first stacking assembly 10 corresponds to the Y direction, and the height direction of the first stacking assembly 10 corresponds to the Z direction. The length direction of the second stacking assembly 40 corresponds to the Y direction, the width direction of the second stacking assembly 40 corresponds to the X direction, and the height direction of the second stacking assembly 40 corresponds to the Z direction.

For example, in the present embodiment, two sides of a top of the first stacking assembly 10 are provided with a group of the first mating structure 20 and the third mating structure 30 along the X direction, and the third mating structure 30 is the same as the first mating structure 20 and disposed opposite to the first mating structure 20. Two sides of a bottom of the second stacking assembly 40 are provided with a group of the second mating structure 50 and the fourth mating structure 60 along the X direction, and the fourth mating structure 60 is the same as the second mating structure 50 and disposed opposite to the second mating structure 50.

Furthermore, two sides of the top of the first stacking assembly 10 are provided with a group of the first mating structure 20 and the third mating structure 30 along the Y direction, and the third mating structure 30 is the same as the first mating structure 20 and disposed opposite to the first mating structure 20. Two sides of the bottom of the second stacking assembly 40 are provided with a group of the second mating structure 50 and the fourth mating structure 60 along the Y direction, and the fourth mating structure 60 is the same as the second mating structure 50 and disposed opposite to the second mating structure 50.

Furthermore, in the present embodiment, the third mating structure 30 and the first mating structure 20 are the same and symmetrically disposed on two opposite sides of the first stacking assembly 10 along an axis of the stacking assembly 1. The fourth mating structure 60 and the second mating structure 50 are the same as and symmetrically disposed on two opposite sides of the stacking assembly 1 along an axis of the second stacking assembly 40.

In other embodiments, the first mating structure 20 can be different from the third mating structure 30. For example, the third mating structure 30 is configured as a third mating portion disposed on the top of the first stacking assembly 10. The fourth mating structure 60 is configured as a fourth mating portion disposed on the bottom of the second stacking assembly 40. When the second stacking assembly 40 is stacked on the first mating structure 10, the third mating portion can be engaged with the fourth mating structure, so as to be in fit with the first mating structure 20 and the second mating structure 40 to limit the second stacking assembly 40 relative to the first stacking assembly 10 from moving along the X direction, the Y direction and the Z direction. The third mating portion and the fourth mating portion can both be an engaging plate and engaged with each other. Alternatively, one of the third mating portion and the fourth mating portion can be a recess hole, the other of the third mating portion and the fourth mating portion can be a protrusion, and the third mating portion can be engaged with the fourth mating portion.

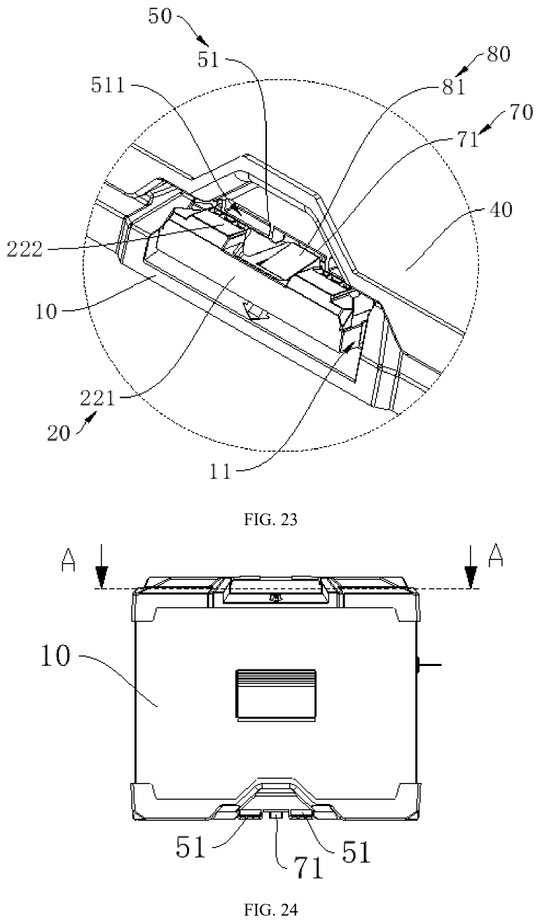

Referring to FIGS. 23 to 35, furthermore, in the present embodiment, the first moving component 22 can be slidably connected to the first stacking assembly 10, which is easy to operate and stable.

Alternatively, a sliding direction of the first moving component 22 is consistent with the X direction or the Y direction. In the present embodiment, the first moving component 22 can move along the X direction of the first stacking assembly 10 or the Y direction of the first stacking assembly 10 towards an outside of the first stacking assembly 10. In the present embodiment, the X direction refers to a length direction of the first stacking assembly 10. The Y direction refers to a width direction of the first stacking assembly 10. The Z direction refers to a height direction of the first stacking assembly 10.

Referring to FIGS. 16 to 35 and FIGS. 36 to 41, alternatively, in the present embodiment, the first moving component 22 can move along the X direction (i.e., the length direction) of the first stacking assembly 10. The first moving component 22 includes a base 221 and a first engaging portion 222 disposed on the base 221. The base 221 is slidably connected to the first stacking assembly 10. The second mating structure 50 includes a second engaging portion 51 disposed on the second stacking assembly 40. The first engaging portion 222 can be snapped onto the second engaging portion 51 by the first elastic structure 21 at the locked state, so as to restrict at least the second stacking assembly 40 from detaching from the first stacking assembly 10 along the Z direction.

A specific structure of the first engaging portion 222 and a specific structure of the second engaging portion 51 may be changed as required, so as to restrict the first moving component 22 relative to the first stacking assembly 10 from moving along at least one of the X direction and the Y direction. Correspondingly, the third mating structure 30 and the fourth mating structure 60 can restrict the second stacking assembly 40 from moving along the other direction, such that the first stacking assembly 10 and the second stacking assembly 40, relative to each other, does not move along the X direction, the Y direction and the Z direction.

Alternatively, in the present embodiment, the first engaging portion 222 protrudes from the base 221, and the second engaging portion 51 protrudes from the bottom of the second stacking assembly 40. The first engaging portion 222 protruding from the base 221 and the second engaging portion 51 protruding from the bottom of the second stacking assembly 40 are relative, it does not represent that the first engaging portion 222 protrudes from a whole surface of the base 221 or the second engaging portion 51 protrudes from a whole surface of the bottom of the second stacking assembly 40. The meaning of protrusion in the following description will not be repeated, as long as it can achieve required functionality.

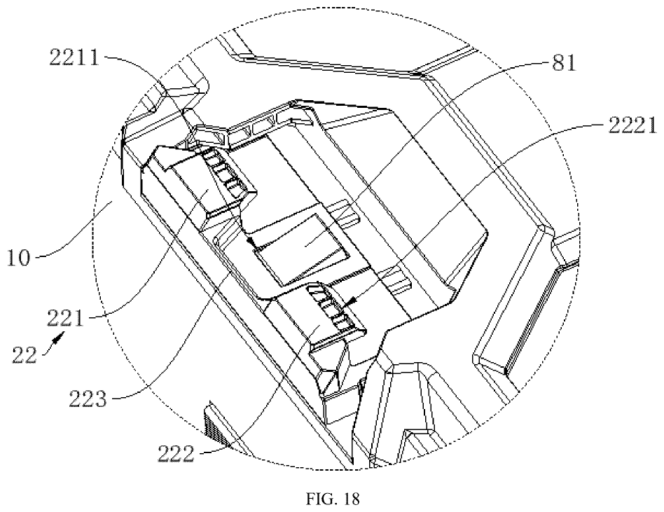

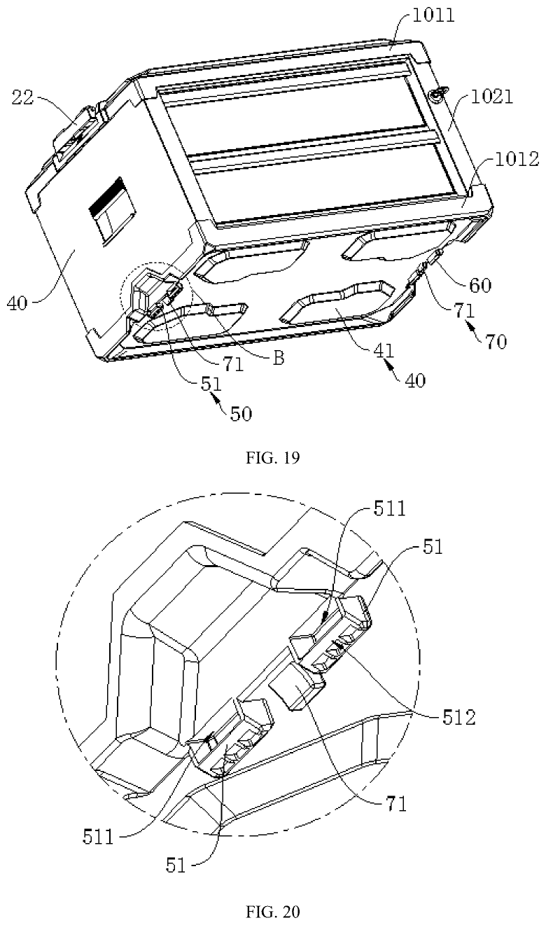

Referring to FIGS. 19 and 21, alternatively, in the present embodiment, the second engaging portion 51 can protrude from or not protrude from the bottom of the second stacking assembly 40. As long as a whole structure of the bottom of the second engaging portion 40 does not influence that the second stacking assembly 40 is stacked on the first stacking assembly 10 to realize an automatic lock by the gravity of the second stacking assembly 40. For example, in the present embodiment, the bottom of the second engaging portion 40 can be provided with a recessed region (not shown). The second engaging portion 51 protrudes from the recessed region, but does not protrude from the other part of the bottom of the second stacking assembly 40.

Referring to FIGS. 16, 17, 19 and 20, in order to facilitate the first engaging portion 222 being engaged with the second engaging portion 51, one of the first engaging portion 222 and the second engaging portion 51 can be provided with an inserting leg, and the other one of the first engaging portion 222 and the second engaging portion 51 is provided with an insertion groove 511. The insertion groove 511 can have one or more notch, so as to selectively limit the second stacking assembly 40 from moving as required. In other words, the insertion groove 511 of different shapes can be in fit with the corresponding inserting leg to limit the second stacking assembly 40 from moving along one or more direction.

In the present embodiment, the first engaging portion 222 includes the inserting leg (not shown), and the second engaging portion 51 is provided with an insertion groove 511. The inserting leg of the first engaging portion 222 can be inserted into the insertion groove 511 by the first elastic structure 21. Referring to FIG. 5, furthermore, in the present embodiment, the insertion groove 511 is a recessed shape, i.e., the insertion groove 511 only have one opening. Therefore, a side wall around the insertion groove 511 can both play a limiting role. An upper side wall of the insertion groove 511 and a lower side wall of the insertion groove 511 can limit the second stacking assembly 40 from moving along the Z direction. A left side wall of the insertion groove 511 and a right side wall of the insertion wall 511 can limit the second stacking assembly 40 from moving along the Y direction. A side wall of the insertion groove 511 opposite to the opening of the insertion groove can limit the second stacking assembly 40 from moving away from the opening of the insertion groove along the X direction.

In other embodiments, the insertion groove 511 can only have an upper side wall and a lower side wall, so as to selectively restrict the second stacking assembly 40 from moving along the Z direction. Correspondingly, the third mating structure 30 can be in fit with the fourth mating structure 40 to limit the second stacking assembly 40 from moving along the X direction and the Y direction.

Referring to FIGS. 16, 19, and FIGS. 22 to 29, in the present embodiment, the top of the first stacking assembly 10 is provided with a moving groove 11. The moving groove 11 is configured to mount the first moving component 22. The moving groove 11 includes a first notch 111 and a second notch 112. The first notch 111 is in communication with the second notch 112. The first notch 111 is disposed on a side wall of the first stacking assembly 10. The second notch 112 is disposed on a top wall of the first stacking assembly 10. The first moving component 22 can move towards the first notch 111.

Referring to FIG. 29, a side wall of the moving groove 11 opposite to the first notch 111 is defined as a first side wall 113. Two opposite side walls of the moving groove 11 are both defined as a second side wall 114. A bottom wall of the moving groove 11 opposite to the second notch 112 is named as the bottom wall 115. In the present embodiment, the first elastic structure 21 is disposed towards the first side wall 113. An arrangement direction of the first elastic structure 21 is parallel to the length direction of the first stacking assembly 10.

Furthermore, referring to FIGS. 16 to 23, in the present embodiment, the third mating structure 30 is the same as the first mating structure 20 and disposed opposite to the first mating structure 20. The fourth mating structure 60 is the same as the second mating structure 50 and disposed opposite to the second mating structure 50. By such arrangement, it facilitates quickly stacking and locking the first stacking assembly 10 and the second stacking assembly 40, and the first mating structure 20 and the third mating structure 30 can be in fit with the second mating structure 50 and the fourth mating structure 60, so as to prevent a relative displacement between the second stacking assembly 40 and the first stacking assembly 10 from moving along the Z direction and the Y direction.

Furthermore, in an embodiment of the present embodiment, a side of the second engaging portion 51 away from to the opening of the insertion groove 511 can abut against the first side wall 113. By such arrangement, the second engaging portion 51 of the second mating structure 50 can fit with the second engaging portion 51 of the fourth mating structure 60, so as to limit the second stacking assembly 40 from moving along the X direction. Therefore, at the locked state, the first engaging portion 222 can be engaged with the second engaging portion 51, the first stacking assembly 10 can be stably stacked on the second stacking assembly 40, and the first stacking assembly 10 does not need to be separated from the second stacking assembly 40 along the X direction, the Y direction and the Z direction.

In other embodiments, a side, away from the opening of the insertion groove 511, of the second engaging portion 51 may not abut against the first side wall 113, and the second stacking assembly 40 can be limited from moving along the X direction by other ways. For example, a position of the first mating structure 20 opposite to the bottom of the second stacking assembly 40 and a position of the third mating structure 30 opposite to the third mating structure 30 are both provided with an additional abutting protrusion. At the locked state, the abutting protrusion opposite to the first mating structure 20 can abut against the first side wall 113 of the moving groove 11 where the first mating structure 20 is located. The abutting protrusion can restrict the second stacking assembly 40 from moving towards the third mating structure 30 along the X direction. Furthermore, at the locked state, the abutting protrusion opposite to the third mating structure 30 can abut against the first side wall of the moving groove 11 where the third mating structure 30 is located, and the abutting protrusion can limit the second stacking assembly 40 from moving towards the first mating structure 20 along the X direction. Therefore, the first stacking assembly 10 and the second stacking assembly 40 can be limited from moving along the X direction without the second engaging portion 51.

As long as the abutting protrusion can be in fit with a side wall of the moving groove 11 to limit the second stacking assembly 40 from moving along the X direction, a position of the abutting protrusion can be flexibly changed. The abutting protrusion can be singly disposed or can be integrated with other structures.

Furthermore, the stacking assembly 1 further includes at least one of a fifth mating structure 12 and a sixth mating structure 41. The fifth mating structure 12 is disposed on the top of the first stacking assembly 10. The sixth mating structure 41 is disposed on the bottom of the second stacking 40. When the second stacking assembly 40 is stacked on the first stacking assembly 10, the fifth mating structure 12 can be in fit with the sixth mating structure 41 to restrict at least the second stacking assembly 40 from moving along the X direction. In other words, in the present embodiment, a movement of the second stacking assembly 40 on the X direction can be limited by cooperation between the fifth mating structure and the sixth mating structure rather than cooperation between the two sides of the second engaging portion 51 or the additional abutting protrusion. Therefore, the position of the second engaging portion 51 can be disposed more flexibly.

Referring to FIGS. 16 to 23, alternatively, in the present embodiment, the fifth mating structure 12 can be in fit with the sixth mating structure 41 to limit the second stacking assembly 40 from moving along the X direction and the Y direction. The fifth mating structure 12 includes a recess disposed on the top of the first stacking assembly 10. The recess is disposed between the first mating structure 20 and the second mating structure 50. The sixth mating structure 41 includes a block disposed on the bottom of the second stacking assembly 40. The block is disposed between the third mating structure 30 and the fourth mating structure 60. When the second stacking assembly 40 is stacked on the first stacking assembly 10, the block can be snapped onto the recess, so as to restrict the second stacking assembly 40 from moving along the X direction and the Y direction. By such arrangement, a movement of the second stacking assembly 40 can be limited from moving along the X direction, and a movement of the second stacking assembly 40 can be limited more firmly from moving along the Y direction. Therefore, the first stacking assembly 10 can be stacked with the second stacking assembly 40 more tightly, and after the first stacking assembly 10 being separated from the second stacking assembly 40, the first stacking assembly 10 and the second stacking assembly 40 can be stably and independently disposed.

Alternatively, in the present embodiment, a shape of an opening of the recess is not circle, surround of the recess is provided with a periphery wall configured to play a restricting role. The block can correspond to the recess one by one, or a plurality of blocks corresponds to one recess, as long as a movement of the second stacking assembly 40 is limited along at least one of the X direction and the Y direction. Furthermore, in other embodiments, a shape of the opening of the recess can be in a circle shape, an arc shape or other shapes.

In other embodiments, the fifth mating structure 12 and the sixth mating structure 41 can be specifically implemented as other structures, as long as a relative displacement between the first stacking assembly 10 and the second stacking assembly 40 can be limited in an auxiliary way by the fifth mating structure 12 and the sixth mating structure 41.

Referring to FIGS. 16 to 23 and FIGS. 36 to 37, in order to facilitate the first moving component 22 being moved by the gravity of the second stacking assembly 40, alternatively, in the present embodiment, the first engaging portion 222 is provided with a first guiding bevel 2221, and the first guiding bevel 2221 is configured to guide when the first engaging portion 222 is inserted to the insertion groove 5111. The first guiding bevel 2221 is disposed on a side of the first engaging portion 222 away from the base 221.

Referring to FIGS. 19 and 20, furthermore, the second engaging portion 51 is provided with a second guiding bevel 512. The second guiding bevel 512 is configured to guide when the first engaging portion 222 is inserted to the insertion groove 511. The second guiding bevel 512 is disposed on a side of the second engaging portion 51 away from the second stacking assembly 40. By such arrangement, in the present embodiment, when the second stacking assembly 40 is disposed on the first stacking assembly 10, the second guiding bevel 512 of the second engaging portion 51 can be in fit with the first guiding bevel 2221 of the first engaging portion 222, such that the first engaging portion 222 can be quickly inserted to the insertion groove 511 to form a locked state.

When the second stacking assembly 40 is stacked on the first stacking assembly 10, the second engaging portion 51 can press the first engaging portion 222 via the gravity of the second stacking assembly 40, a structure of the first guiding bevel 2221 and a structure of the second guiding bevel 512, such that the first moving component 22 can slide on the first stacking assembly 10 to give away, then the second stacking assembly 40 can be stacked in place and in contact with the second stacking assembly 40, after the second stacking assembly 40 being stacked in place, the first engaging portion 222 can be quickly inserted to the insertion groove 511 by the elastic effect of the first elastic structure 21, so as to achieve a completely locking process.

Referring to FIG. 36, alternatively, in the present embodiment, the base 221 is provided with two first engaging portions 222. The two first engaging portion 222 are disposed at interval, by such arrangement, engagement reliable of the first stacking assembly 10 and the second stacking assembly 40 can be further improved.

Referring to FIGS. 36 and 37, alternatively, in the present disclosure, the first moving component 22 further includes an auxiliary portion 223. The auxiliary portion 223 is disposed on the base 221 and between the two first engaging portions 222. The auxiliary portion 223 is configured to provide an applying position, facilitating the operator applying and pulling the first moving component 22.

The auxiliary portion 223 can be a concave edge portion disposed on the base 221 or other characteristic portions, in which the other characteristic portions can assist to pull the base 221 to move. The other characteristic portions can be a recess portion or a portion having a relative large rough surface, such as a silicone and a rubber part.

Alternatively, in the present embodiment, two or three of the base 221, the first engaging portion 222 and the auxiliary portion 223 can be integrated with each other. By such arrangement, it is conducive to processing.

Referring to FIGS. 16 to 18, in an embodiment of the present disclosure, the first mating structure 20 is disposed on a middle of a side of the first stacking assembly 10 along the width direction of the first stacking assembly 10, a movement of the first moving component 22 is parallel to a side surface of the first stacking assembly 10, in which the side surface of the first stacking assembly 10 is disposed along the width direction of the first stacking assembly 10. In other embodiments, a position of the first mating structure 20 can be designed as required. The first mating structure 20 can be disposed on a side of the first stacking assembly 10 along the length direction of the first stacking assembly 10 and not disposed on the middle of the side of the first stacking assembly 10 along the width direction of the first stacking assembly 10.

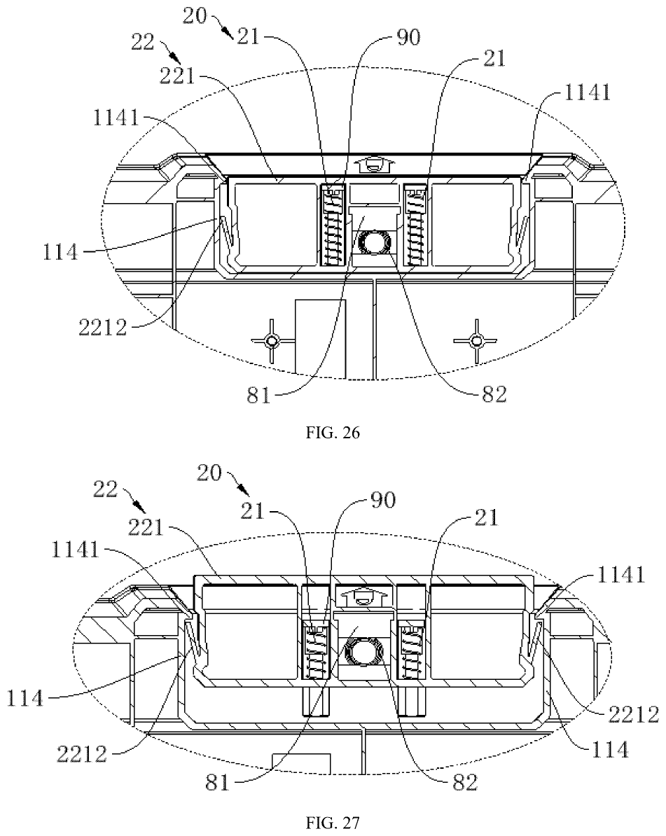

Referring to FIGS. 26 and 27, in the present embodiment, the stacking assembly 1 further includes a mounting base 90. The first elastic structure 21 is mounted on the first stacking assembly 10 via the mounting base 90. Therefore, a position of the first elastic structure 21 can be more stable, so as to ensure stability of a sliding direction of the first moving component 22.

The mounting base 90 is fixed on the bottom wall 115 of the moving groove 11. The mounting base 90 can be integrated with the bottom wall 115, alternatively, the mounting base 90 can be singly molded and then mounted on the bottom wall 115. Furthermore, the mounting base is in an L shape. The mounting base 90 includes a first mounting plate abutting against the bottom 115 and a second mounting plate perpendicular to the first mounting plate. An end of the first elastic structure 21 abuts against the second mounting plate of the mounting base 90, and the other end of the first elastic structure 21 abuts against the first moving component 22, such that the first elastic structure 21 can drive the first moving component 22 to move more stably.

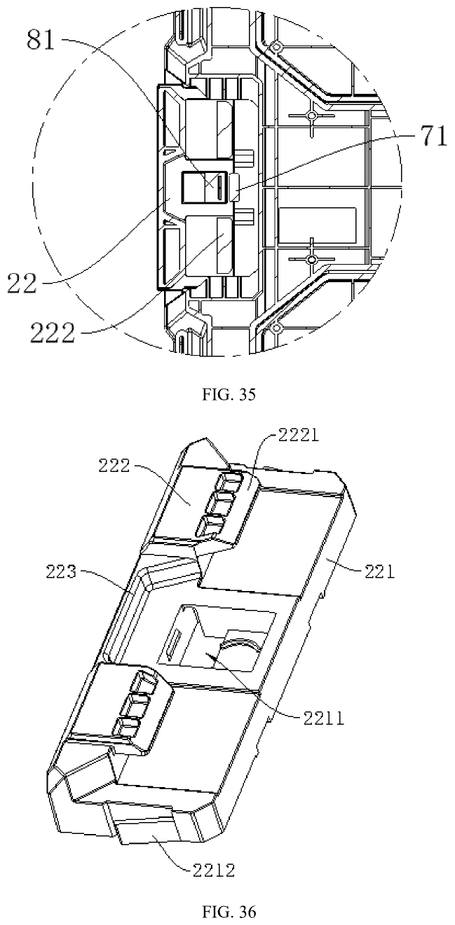

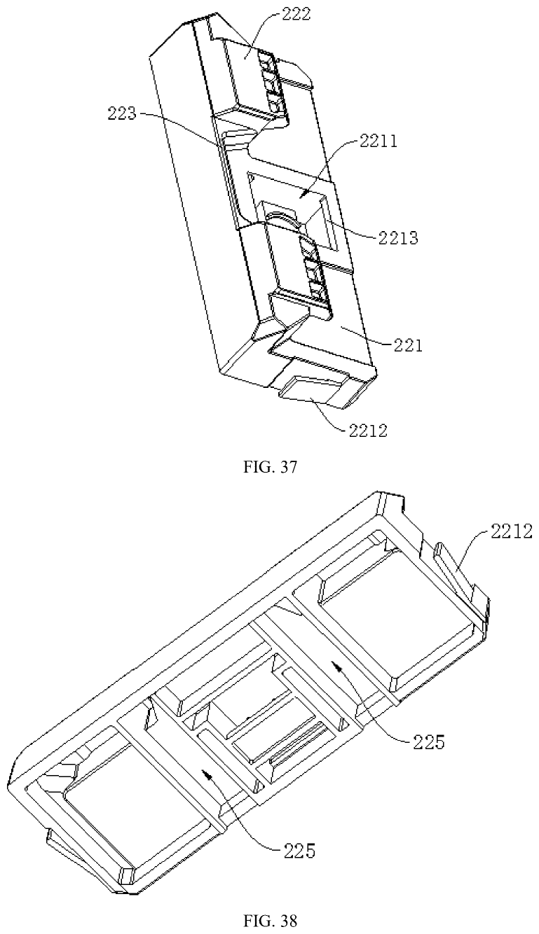

Referring to FIG. 38, furthermore, in order to further ensure mounting stability of the first elastic structure 21 and sliding stability of the first moving component, the first moving component 22 is provided with a slide groove 225. The first elastic structure 21 and the mounting base 90 can be disposed in the slide groove 225 to ensure the mounting base 90 to be in fit with the slide groove 225, such that the first elastic structure 21 can drive the first moving component 22 more stably and reliably. In the present embodiment, the slide groove 225 includes a first groove area and a second groove area. The first groove area is configured to accommodate the second mounting plate of the mounting base 90, and the second groove area is configured to accommodate the first mounting plate of the mounting base 90 and the first elastic structure 21 disposed on the first mounting plate, so as to ensure the first moving component 22 to slide front and back on the bottom wall 115.

Referring to FIGS. 24 to 27 and FIGS. 36 to 38, in the present embodiment, two opposite sides of the moving groove 11 are provided with a first limiting portion 1141, two opposite sides of the first moving component 22 are both provided with a second limiting portion 2212. The first limiting portion 1141 can fit with the second limiting portion 2212 to limit a movable distance or a rotatable range of the first moving component 22.

Referring to FIGS. 20 to 23, in the present disclosure, after the second stacking assembly 40 being stacked on the first stacking assembly 10, the first moving component 22 can be moved on the first stacking assembly 10 and does not protrude from the side wall of the first stacking assembly 10. By such arrangement, a risk of the first moving component 22 being locked or unlocked due to a limited moving distance or a limited moving range, which are in a narrow space, can be prevented or minimized.

In other embodiments, when it does not affect the first stacking assembly 10 being stacked with and locked with the second stacking assembly 40, the first moving component 22 can move on the first stacking assembly 10 and protrude from the side wall of the first stacking assembly 10 after the second stacking assembly 40 being stacked with the first stacking assembly 10.

Furthermore, referring to FIGS. 16 to 35, in the present embodiment, the positioning assembly 80 is disposed on the first mating structure 20, the first mating structure 20 can drive the positioning assembly 80 to move to a positioning position under the external force, such that the first limiting connecting mechanism 2001 and the second limiting connecting mechanism 5001 can be switched from the locked state to the unlocked state. The positioning assembly 80 is disposed on the first mating structure 20, such that the positioning assembly 80 is synchronized with the first mating structure 20, facilitating operating and quickly forming the unlocked state. In other embodiments, the positioning assembly 80 can be disposed on at least one of the first stacking assembly 10 and the second stacking assembly 40.

Referring to FIGS. 16 to 23 and FIGS. 39 to 41, in the present embodiment, the positioning assembly 80 includes a positioning member 81 and a second component 82. The second elastic component 82 elastically acts on the positioning member 81. The second stacking assembly 40 is further provided with a positioning mating portion 70. The positioning component 80 follows the first moving component 22 to move to the positioning position, the positioning member 81 can abut against the positioning mating portion 70 by an elastic force of the second elastic component 82, so as to prevent the first elastic component 21 from driving the first moving component 22 to move.

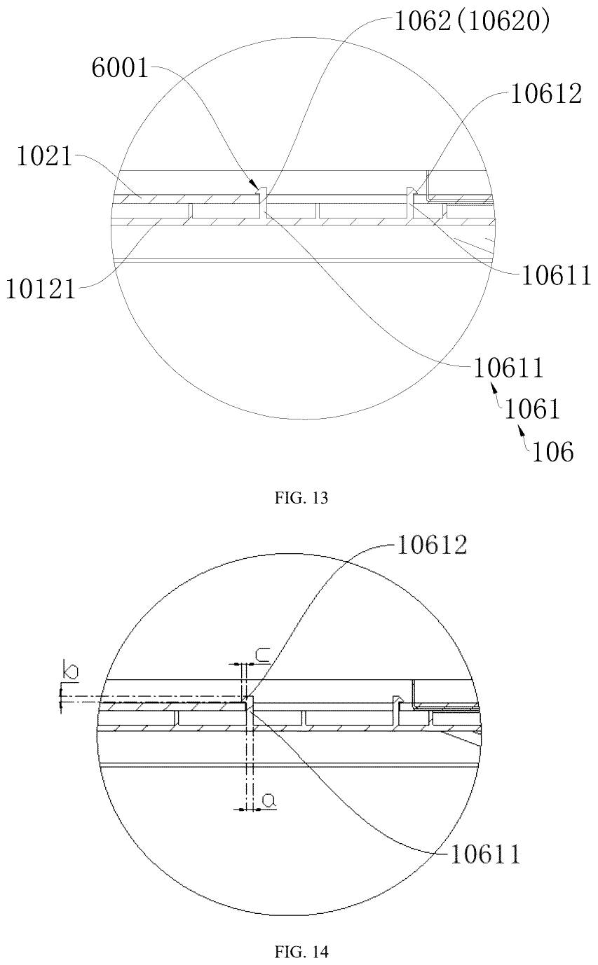

Referring to FIGS. 13 to 23 and FIGS. 39 to 41, in the present embodiment, the base 221 is provided with a first assembly groove 2211. The positioning assembly 80 can be flexibly mounted on the first assembly groove 2211. When the positioning assembly 80 is at the locked state, the positioning member 81 can be rotated in the first assembly groove 2211 and compress the second elastic component 82 by the positioning mating portion 70. When the positioning assembly 80 is at the unlocked state, the first moving component 22 can drive the positioning assembly 80 to move to the positioning position under the external force, and the positioning member 81 can abut against the positioning mating portion 70, so as to prevent the first elastic component 21 from driving the base 221 to slide. The external force can be removed when the positioning assembly 80 reaches to the positioning position, the positioning member 81 can be snapped onto and abut against the positioning mating portion 70 under the elastic force of the second elastic component 82, so as to remain the stacking system at the unlocked state, and the second stacking assembly 40 can be directly moved from the first stacking assembly 10 by the operator.

Referring to FIGS. 19 to 23, alternatively, in the present embodiment, the positioning mating portion 70 can be a protrusion 71 disposed on the bottom of the second stacking assembly 40. When the positioning member 81 is at the unlocked state, the positioning member 81 can abut against an outside side of the protrusion 71 by the elastic force of the second elastic component 82. In other embodiment, the positioning portion 70 can be the side wall of the second stacking assembly 40.

Referring to FIGS. 13 to 23 and 39 to 41, alternatively, in the present embodiment, a side of the positioning member 81 away from the bottom 115 of the first assembly groove 2211 is provided with an inclined abutting surface 811. When the first moving component 22 slides outside the first stacking assembly 10, the inclined abutting surface 811 can facilitate the positioning member 81 reaching to the positioning position quickly, such that the positioning member 81 can quickly abut against the positioning abutting portion 70.

The positioning mating portion 70 can abut against the inclined abutting surface 811 at the locked state, so as to prevent the positioning member 81 from rotating and detaching from the first assembly groove 2211 by the second elastic component 82.

In other embodiments, when the two positioning mating portions 70 are both the protrusion disposed on the bottom of the second stacking assembly 40, such that the two positioning mating portions 70 can be regarded as the abutting protrusions, i.e. Two positioning mating portions 70 can play a positioning role and can restrict the second stacking assembly 40 from moving along the X direction. In the above state, a side of the positioning mating portion 70 towards a center of the second stacking assembly 40 can abut against the first side wall 113. In other embodiments, the first side wall 113 can be provided with an abutting block, such that the positioning mating portion 70 can abut against and restrict the abutting block of the first side wall 113, as long as the second stacking assembly 40 does not move relative to the first stacking assembly 10 along the X direction.

Referring to FIG. 41, alternatively, in the present embodiment, a side of the positioning member 81 abutting against the positioning mating portion 70 is an arc abutting surface 812. By such arrangement, it can ensure a positioning effect of the positioning member 81 and facilitate the positioning member 81 rotating in the first assembly groove 2211. Correspondingly, a side of the positioning mating portion 70 abutting against the positioning member 81 can be the arc abutting surface. It is further conducive for the positioning member 81 abutting against the positioning mating portion 70 and rotating the positioning member 81 in the first assembly groove 2211.

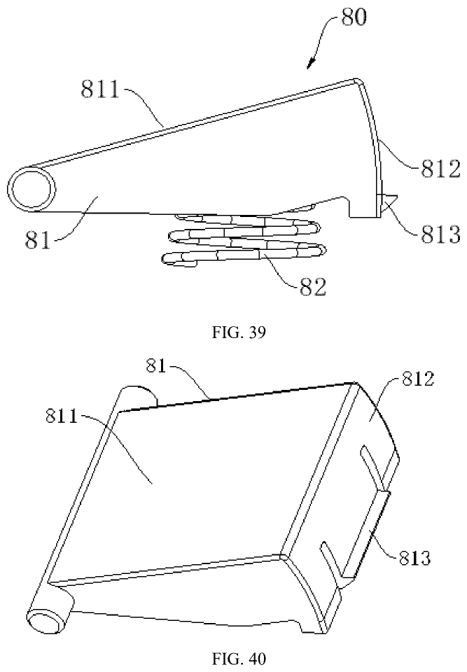

Referring to FIGS. 39 and 41, alternatively, in the present embodiment, the arc abutting surface 812 is provided with a third limiting portion 2213, a groove wall of the first assembly groove 2211 corresponding to the arc abutting surface 812 is provided with a fourth limiting portion 813. When the positioning member 81 rotates away from the bottom 115 of the first assembly groove 2211 under the elastic force of the second elastic component 82, the fourth limiting portion 813 can be snapped onto the third limiting portion 2213. By such arrangement, stability of the positioning member 81 can be remained, and the positioning member 81 can be prevented from detaching from the first assembly groove 2211.

Referring to FIG. 41, alternatively, in the present embodiment, the second elastic component 82 is a tower spring. The tower spring has a small volume, a large load capacity, and a strong variable stiffness, is suitable for small spaces and capable of withstanding greater pressure, and has great shock absorption and rebound effects. In other embodiments, the second elastic component 82 includes but not limit to the tower spring, a compression spring, a torsion spring, a shrapnel and so on.

The top of the first stacking assembly 10 can be provided with a plurality of first limiting connecting mechanisms 2001. Each of the plurality of first limiting connecting mechanisms 2001 can include one or more first mating structures 20 and one or more third mating structures 30. Each of the plurality of first limiting connecting mechanisms 2001 positions one second stacking assembly 40. In other words, the first stacking assembly 10 positions one second stacking assembly 40 via a group consisting of one or more first mating structure 20 and one or more third mating structure 30. The number and the position of the first mating structure 20 and the number and the position of the third mating structure 30 required for positioning one second stacking assembly 40 can be selected as required, such that the top of the first stacking assembly 10 can fix the second stacking assemblies 40 of different sizes and/or different numbers.

The number of the second mating structure 50 and the position of the second mating structure 50 on the second stacking assembly 40 and the number of the fourth mating structure 60 and the position of the fourth mating structure 60 on the second stacking assembly 40 does not completely correspond to the number of the first mating structure 20 and the position of the first mating structure 20 on the first stacking assembly 10 and the number of the third mating structure 30 and the position of the third mating structure 30 on the first stacking assembly 10. It only requires to correspond to the number of the first mating structure 20 and the position of the first mating structure 20 on the first stacking assembly 10 and the number of the third mating structure 30 and the position of the third mating structure 30 on the second stacking assembly 40, in which the first mating structure 20 of the first stacking assembly 10 and the third mating structure 30 of the first stacking assembly 10 are configured to fix the second stacking assembly 40.

Therefore, when the first stacking assembly 10 is in fit with the second stacking assembly 40 and the position of the first mating structure 20 on the first stacking assembly 10 configured to fix the second stacking assembly 40 are certain, the other parts of the first stacking assembly 10 capable of being in locked with the second stacking assembly 40 can be regarded as the third mating structure 30.

At least one of the top of the first stacking assembly 10 and the top of the second stacking assembly 40 is capable of fixing the second stacking assemblies 40 of different sizes by flexibly providing the first mating structure 20 and the third mating structure 30.

Referring to FIGS. 16 to 23, alternatively, in the present embodiment, the second mating structure 50 and the fourth mating structure 60 are further disposed on a side of the first stacking assembly 10 away from the first mating structure 20 and the third mating structure 30. Alternatively, the first mating structure 20 and the third mating structure 30 are further disposed on a side of the second mating structure 40 away from the second mating structure 50 and the fourth mating structure 60. By such arrangement, an upper side and a lower side of the first stacking assembly 10 and an upper side and a lower side of the second stacking assembly 40 can both be stacked with and locked with other different stacking assemblies 1 via the first mating structure 20, the third mating structure 30, the second mating structure 50 and the fourth mating structure 60.

The first stack 10 is relatively away from the second stack 40, in the present embodiment, the side of the first stacking assembly 10 away from the first mating structure 20 and the third mating structure 30 is provided with the second mating structure 50 and the fourth mating structure 60, i.e. the bottom of the first stacking assembly 10 is further provided with the second mating structure 50 and the fourth mating structure 60. The side of the second mating structure 40 away from the second mating structure 50 and the fourth mating structure 60 is further provided with the first mating structure 20 and the third mating structure 30, i.e., the top of the second stacking assembly 40 is further provided with a first mating structure 20 and a third mating structure 30. Therefore, the upper side of each of the plurality of stacking assembly 1 and the lower side of each of the plurality of stacking assembly 1 can both be stacked with and locked with other stacking assemblies 1.

The naming of the above first stacking assembly 10 and the naming of the above second stacking assembly 40 are relative. For example, when three stacking assemblies 1 are stacked with each other along the height direction, middle one of the three stacking assemblies 1 is regarded as the second stacking assembly 40 relative to lower one of the three stacking assemblies 1 and as the first stacking assembly 10 relative to upper one of the three stacking assemblies 1.

In other embodiments, when the first stacking assembly 10 is provided with a plurality of third mating structures 30, a part of the plurality of third mating structures 30 can be the same as the first mating structure 20, a part of the plurality of third mating structures 30 can be different from the first mating structure 20. A position of the third mating structure 30 can be determined relative to the size of the second stacking assembly 40 stacked on the first stacking assembly 10.

Referring to FIGS. 16 to 21, one side of the top of the first stacking assembly 10 and one side of the top of the second stacking assembly 40 are both provided with the first mating structure 20, and the other end of the top of the first stacking assembly 10 and the other side of the top of the second stacking assembly 40 are both provided with a limiting structure, and the limiting structure is the same as the first mating structure 20. A middle area of the top of the first stacking assembly 10 and a middle area of the top of the second stacking assembly 40 can be provided with two groups of the limiting structure, respectively, and the limiting structure is implemented as an engaging plate.

When the size of the second stacking assembly 40 is the same as that of the first stacking assembly 10, the limiting structure, which is the same as the first mating structure 20, is regarded as the third mating structure 30. When the size of the second stacking assembly 40 is less than that of the first stacking assembly 10, the limiting structure, which is the same as the first mating structure 20, can be another first mating structure 20, two first mating structures 20 are in fit with one of the two groups of the engaging plate, respectively, to lock one second stacking assembly 40. The corresponding one of the two groups of the engaging plate is regarded as the third mating structure 30. In the present embodiment, the first mating structure 20 each is in fit with the two groups of the engaging plate to lock the second stacking assembly 40, i.e., one first mating structure 20 and two third mating structures 30, which is implemented as the engaging plate, are configured to lock one corresponding second stacking assembly 40. Therefore, the first stacking assembly 10 and the second stacking assembly 40 can be stacked with the plurality of stacking assemblies 1 of different sizes as required.

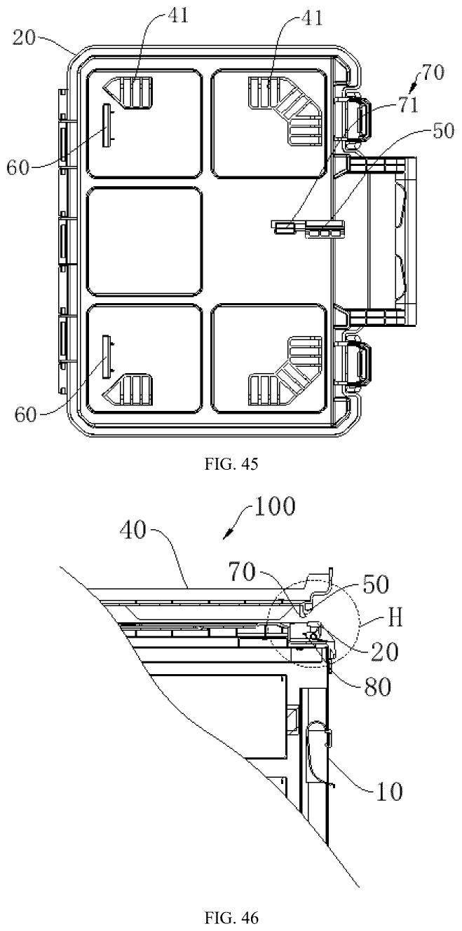

Referring to FIGS. 44 and 45, a second embodiment of the present disclosure provides a stacking assembly, a conception and a large part of structures of the stacking assembly in the second embodiment are substantially the same as that of the stacking assembly in the first embodiment, except that, in the second embodiment, the first elastic structure 21 is connected to one second side wall 114 of the moving groove 11, a sliding direction of the first moving component 22 is the same as the width direction of the first stacking assembly 10, i.e., the first moving component 22 can slide along the Y direction.

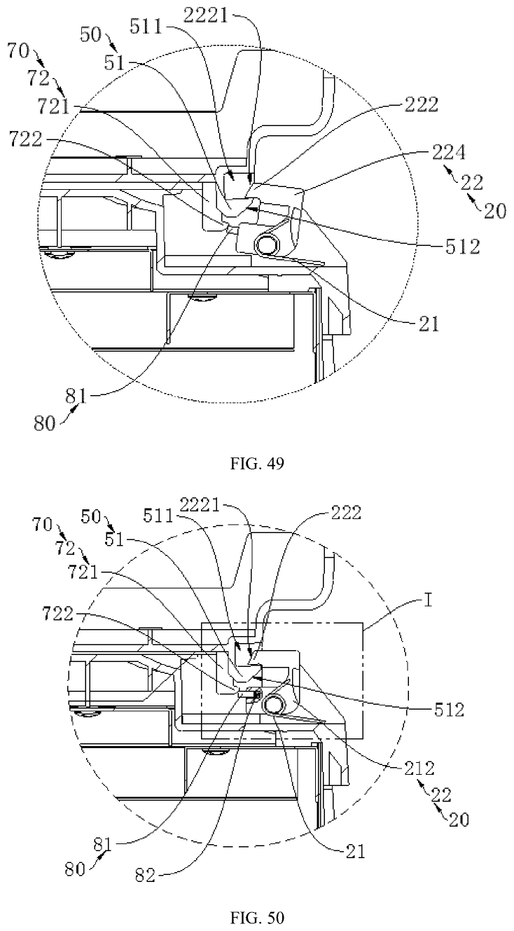

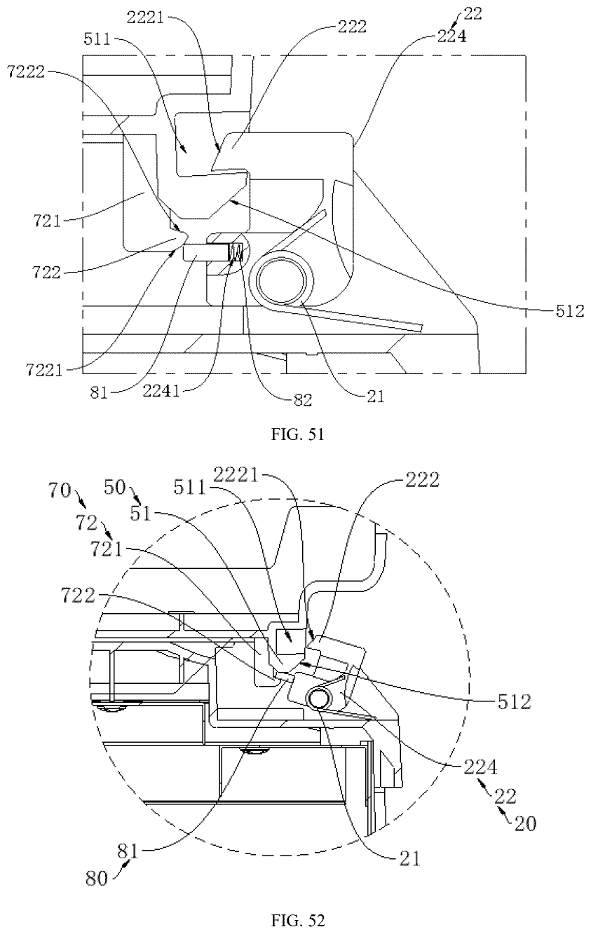

Referring to FIGS. 46 to 52, a third embodiment of the present disclosure provides a stacking assembly, a conception and a large part of structures of the stacking assembly in the second embodiment are substantially the same as those of the stacking assembly in the first embodiment, except that, in the third embodiment, the first moving component 22 can be rotatably connected to the first stacking assembly 10.

In the third embodiment, the first moving component 22 includes a rotatable base 224 and a first engaging portion 22 disposed on the rotatable base 224, and the rotatable base 224 can be rotatably connected to the first stacking assembly 10. The second mating structure 50 includes a second engaging portion 51 disposed on the second stacking assembly 40. The second engaging portion 51 is provided with an insertion groove 511. The first engaging portion 222 can be inserted into the insertion groove 511 by an elastic force of the first elastic component 21 at the locked state, so as to limit the second stacking assembly 40 from detaching from the first stacking assembly 10 along the X direction, the Y direction or the Z direction.

Furthermore, the rotatable base 224 is provided with a second assembly groove 2241. The positioning assembly 80 can be flexibly mounted on the second assembly groove 2241. The positioning member 81 can be located at a side of the positioning engaging portion 70 away from the second stacking assembly 40 at the locked state. At the unlocked state, the first moving component 22 can drive the positioning assembly 80 to move to a positioning position by the external force, and the positioning member 81 can abut against the positioning engaging portion 70 by the elastic force of the second elastic component 82, so as to prevent the first elastic structure 21 from driving the rotatable base 224 to rotate.

Referring to FIG. 47, in the present embodiment, the positioning engaging portion 70 is regarded as a catching leg 72 disposed on the bottom of the second stacking assembly 40. The catching leg 72 includes a connecting portion 721 and a hook portion 722. The hook portion 722 is disposed on the bottom of the connecting portion 721. The positioning engaging portion 81 can be driven by the rotatable base 224 to abut against a side of the hook portion 722 towards the second stacking assembly 40.

A side of the hook portion 722 away from the second stacking assembly 40 is provided with a third guiding bevel 7221. When the first stacking assembly 10 and the second stacking assembly 40 are about to be at the unlocked state, the third guiding bevel 7221 is configured to guide when the rotatable base 224 drives the positioning member 81 to rotate. When the first stacking assembly 10 and the second stacking assembly 40 are required to be unlocked, the third guiding bevel 7221 can facilitate the rotatable member 81 driving the positioning member 81 to rotate to the positioning position, so as to prevent the first elastic component 21 from driving the first engaging portion 222 of the rotatable component to be snapped into an insertion groove 511 of the second mating structure 50.

Furthermore, a side of the hook portion 722 towards the second stacking assembly 40 is provided with a fourth guiding bevel 7222. When the first stacking assembly 10 and the second stacking assembly 40 are about to be at the unlocked state, the fourth guiding bevel 7222 is configured to guide when the second stacking assembly 40 moves to detach from the first stacking assembly 10. The fourth guiding bevel 7222 can prevent the hook portion 7222 from getting stuck with the bottom of the positioning member 81, facilitate the second stacking assembly 4 quickly moving to detach from the first stacking assembly 10.

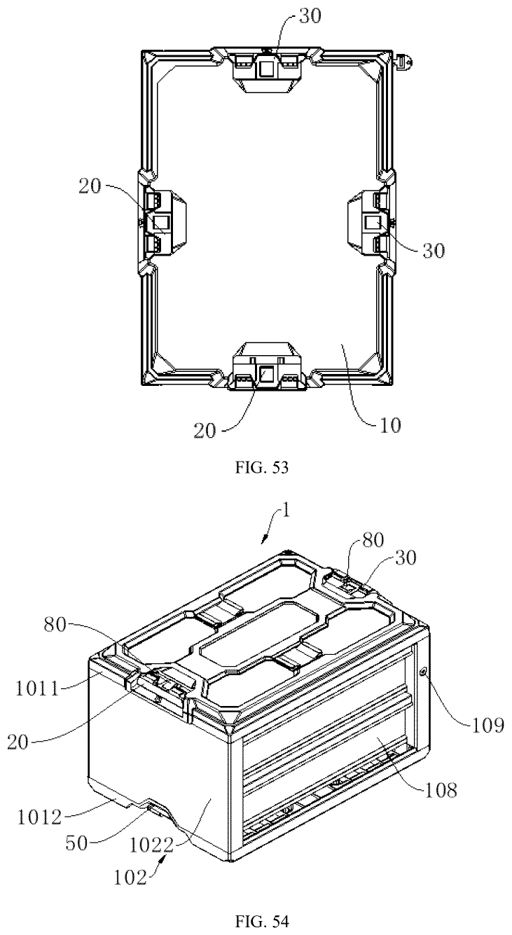

Referring to FIG. 53, furthermore, a fourth embodiment of the present disclosure provides a stacking assembly, a conception and a large part of structures of the stacking assembly in the fourth embodiment are substantially the same as those of the stacking assembly in the first embodiment, except that, in the fourth embodiment, the bottom of the first stacking assembly 10 and the bottom of the second stacking assembly 40 are both a plane. The first stacking assembly 10 and the second stacking assembly 40 includes two groups of the first mating structure 20 and the third mating structure 30. One of the two groups of the first mating structure 20 and the third mating structure 30 is disposed on two sides of a top of the first stacking assembly 10 along the X direction, and the other one of the two groups of the first mating structure 20 and the third mating structure 30 is disposed on two sides of the top of the first stacking assembly 10 along the Y direction. The first stacking assembly 10 and the second stacking assembly 40 includes two groups of the second mating structure 50 and the fourth mating structure 60, one of the two groups of the second mating structure 50 and the fourth mating structure 60 are disposed on two sides of a top of the second stacking assembly 40 along the X direction, and the other one of the two groups of the second mating structure 50 and the fourth mating structure 60 are disposed on two sides of the top of the second stacking assembly 40 along the Y direction. The first limiting connecting mechanism 2001 and the second limiting connecting mechanism 5001 can be in fit with each other by at least one of gravity and additional pressure, such that the first stacking assembly 10 can be stacked with and automatically locked with the stacking assembly 40 along the X direction, the Y direction and the Z direction.

When the second stacking assembly 40 and the first stacking assembly 10 are used, it is only required to directly dispose the second stacking assembly 40 on the first stacking assembly 10, then four first engaging portions 222 can be engaged with corresponding second engaging portions 51 by gravity, such that the stacking system 100 is at the locked state. When the first limiting connecting mechanism 2001 and the second limiting connecting mechanism 5001 is switched from the locked state to the unlocked state, one of the two groups of the first mating structure 20 and the third mating structure 30 can be pulled, and then the other one of the two groups of the first mating structure 20 and the third mating structure 30 is pulled, such that the positioning member 81, which is disposed on four sides of the first stacking assembly 10 or four sides of the second stacking assembly 40, both reaches to a positioning position, so as to make the second stacking assembly 40 move away from the first stacking assembly 10.

Furthermore, a fifth embodiment (not shown) of the present disclosure provides a stacking assembly, a conception and a large part of structures of the stacking assembly in the fifth embodiment are substantially the same as those of the stacking assembly in the first embodiment, except that, in the fifth embodiment, the first mating structure 20 and the third mating structure 30 can be correspondingly disposed on two portions of the top of the first stacking assembly 10 along the X direction or the Y direction, respectively. The second mating structure 50 and the fourth mating structure 60 are correspondingly disposed on two portions of the bottom of the second mating structure 40 along the X direction or the Y direction, respectively. The third mating structure 30 is different from the first mating structure 20. In the present embodiment, the third mating structure 30 includes a third mating portion disposed on a top of the first stacking assembly 10. The fourth mating structure 60 includes a fourth mating portion. When the second stacking assembly 40 is stacked on the first stacking assembly 10, the third mating structure can be engaged with the fourth mating structure, so as to be in fit with the first mating structure 20 and the second mating structure 50 to restrict the first stacking assembly 10 and the second stacking assembly 40 from moving along the X direction, the Y direction and the Z direction.

The third mating portion and the fourth mating portion can be implemented as engaging plates, and can be implemented as a hole and a protrusion, respectively, in which the third mating portion and the fourth mating portion can be engaged with each other.

Alternatively, in the present embodiment, the first mating structure 20 and the third mating structure 30 can be relatively disposed on two sides of the top of the first stacking assembly 10, and the second mating structure 50 and the fourth mating structure 60 are relatively disposed on two sides of the bottom of the second stacking assembly 40. The third mating portion and the fourth mating portion can be implemented as engaging plates engaging with each other.

In other embodiments, an engaging structure of the engaging plate can be changed to correspondingly change an engaging direction of the second stacking member 40, such that after the fourth mating portion being engaged with the third mating portion, the second stacking assembly 40 is limited from moving along the Z direction and the X direction or the Z direction and the Y direction.

A cooperation between the third mating portion and the fourth mating portion can be in combination with that in the first embodiment. In other embodiments, the third mating structure 30 can be the same as or different from the first mating structure 20 to be in fit with the first mating structure 20. As long as the second stacking assembly 40 can be eventually limited from moving along the X direction and the Z direction, or the Y direction and the Z direction.

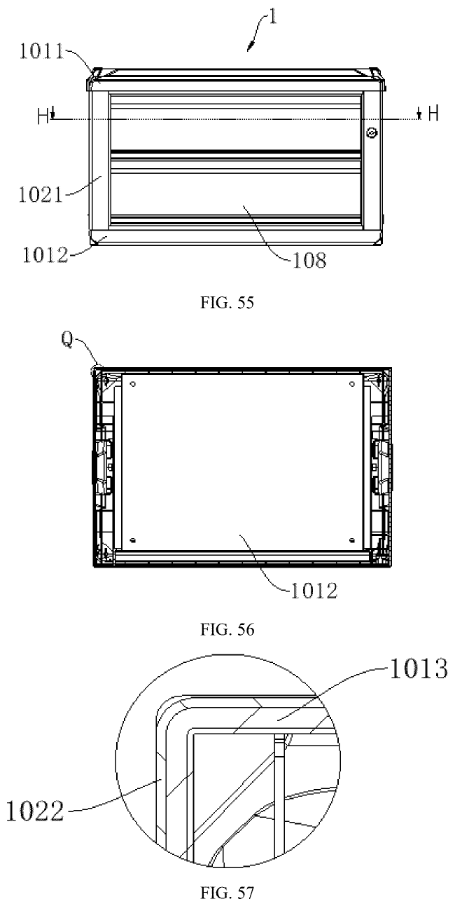

Referring to FIGS. 54 to 57, a sixth embodiment of the present disclosure provides a stacking assembly, a conception and a large part of structures of the stacking assembly in the sixth embodiment are substantially the same as those of the stacking assembly in the first embodiment, except that, in the sixth embodiment, the first connecting member 101 includes an upper cover 1011, a connecting frame 1013 and a lower cover 1012 connected to each other. The upper cover 1011 and the lower cover 1012 are connected to two opposite ends of the connecting frame 1013, respectively. The second connecting member 102 is a sheet metal layer 1022 that surrounds and covers at least part of a periphery of the connecting frame 103, to form the enclosed accommodating space 1011 together with the upper cover 1011, the connecting frame 1013 and the lower cover 1012.

The sheet metal layer 1022 can be fixedly connected to the connecting frame 1013 inside the first connecting member 101 via screws, rivets, or adhesives and so on. Furthermore, in one or more embodiments, a thickness T1 of the sheet metal layer is greater than or equal to 1 mm.

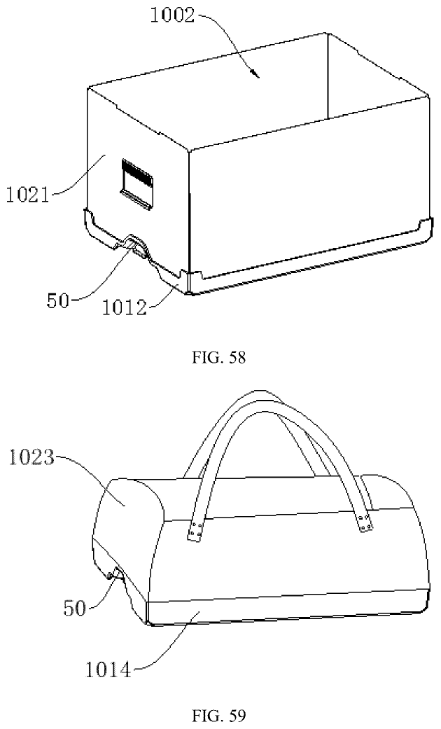

Referring to FIG. 58, a seventh embodiment of the present disclosure provides a stacking assembly, a conception and a large part of structures of the stacking assembly in the seventh embodiment are substantially the same as those of the stacking assembly in the first embodiment, except that, in the seventh embodiment, the first connecting member 101 is defined as the lower cover 1012. The second connecting member 102 is defined as the intermediate housing 1021. The intermediate housing 1021 includes at least one opening. The lower cover 1012 is mounted on a side, opposite to the opening, of the intermediate housing 1021, so as to form the semi-enclosed accommodating space 1001.

The semi-enclosed accommodating space 1001 refers to that at least one side of the periphery of the accommodating space is always an opening, and the other part of the accommodating space is enclosed. For example, the semi-enclosed accommodating space 1001 can be in a basket shape.

Referring to FIG. 59, an eighth embodiment of the present disclosure provides a stacking assembly, a conception and a large part of structures of the stacking assembly in the eighth embodiment are substantially the same as those of the stacking assembly in the first embodiment, except that, in the eighth embodiment, the first connecting component 107 is made of a rigid material, and the second connecting member 102 is made of a flexible material.

Alternatively, the rigid material is plastic, and the flexible material is selected from the group consisting of cloth, leather, and flexible plastic, and any combination thereof.

Referring to FIGS. 21, alternatively, in the present embodiment, the first connecting member 101 is defined as a bottom support 1014, and the second connecting member 102 is defined as a bag 1023.

Referring to FIGS. 16 to 41, a stacking system 100 of the present disclosure is further provided. The stacking system includes a plurality of stacking assemblies 1 stacked with and locked with each other along the Z direction.

Comparing with a related technology, in the present disclosure, the plurality of stacking assemblies 1 in the stacking system 100 provided in the present disclosure can be quickly stacked with and locked with each other, ensuring transportation stability and fully utilizing storage space, so as to ensure safety after stacking. The plurality of stacking assemblies 1 can be easily stacked with each other to lock or unlock.

Referring to FIG. 21, in the present embodiment, the stacking system 100 includes two stacking assemblies 1. The two stacking assemblies 1 are defined as a first stacking assembly 10 and a second stacking assembly 40.

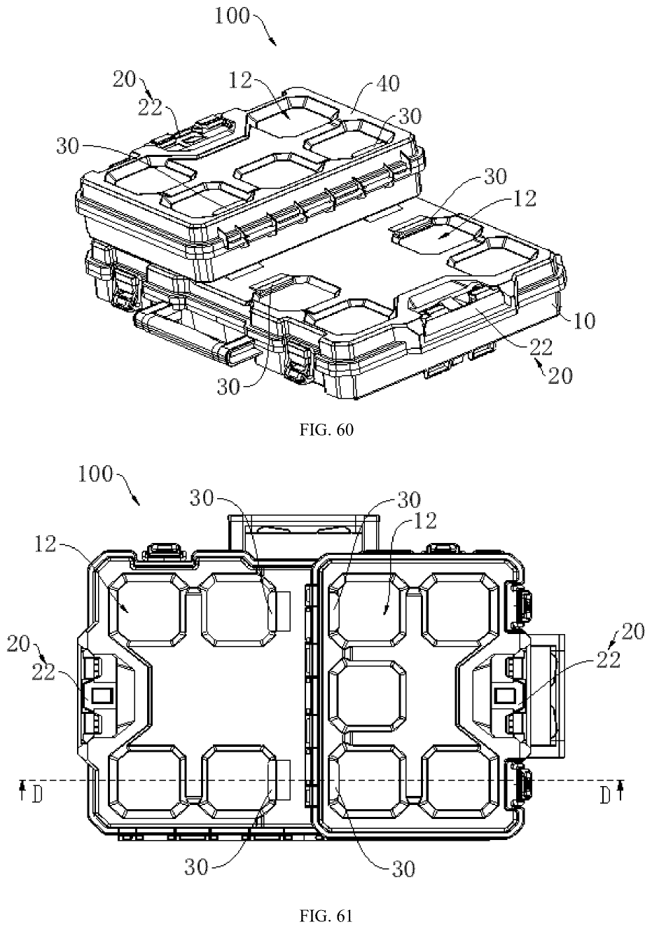

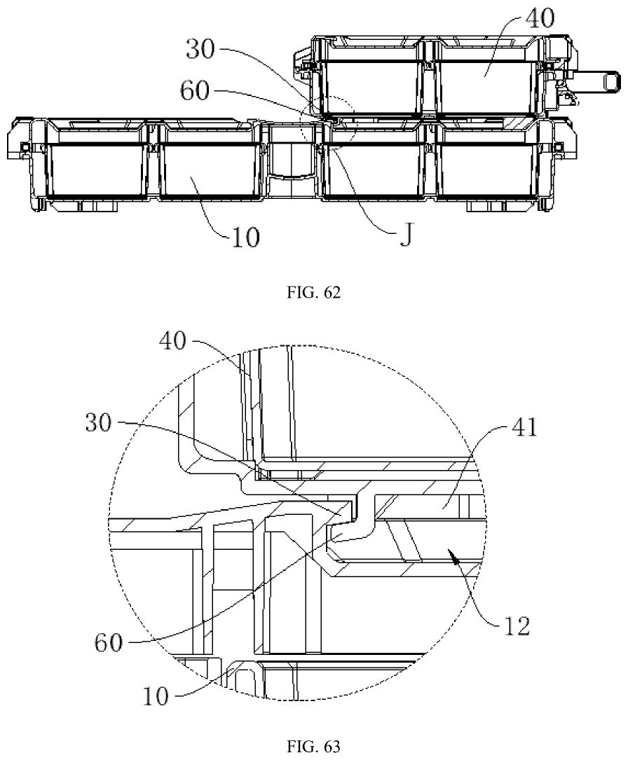

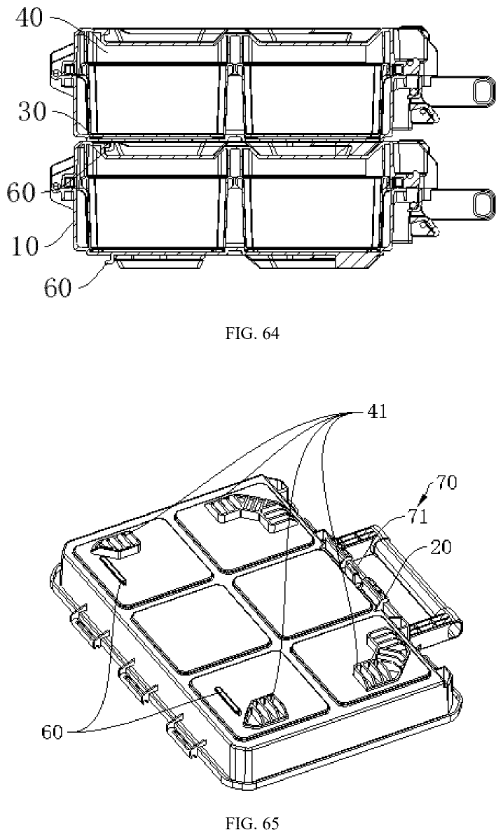

Referring to FIGS. 60 to 65, a ninth embodiment of the present disclosure provides a stacking assembly 1 and a stacking system 100, a conception and a large part of structures of the stacking assembly 1 in the ninth embodiment are substantially the same as those of stacking assembly 1 in the first embodiment, except that, in the ninth embodiment, a length of the first stacking assembly 10 is integer multiple of the width of the second stacking assembly 40. For example, in the present embodiment, the width of the first stacking assembly 10 is the same as the length of the second stacking assembly 40, and the length of the first stacking assembly 10 is twice of the width of the second stacking assembly 40. In the present embodiment, in the stacking system 100, two second stacking assemblies 40 parallel to each other can be stacked on each first stacking assembly 10. In other embodiments, one second stacking assembly 40 or more than three second stacking assemblies 40 can be stacked on each first stacking assembly 10. The length and the width or the size of the second stacking assembly 40 can be designed as required, as long as it does not affect that the first stacking assembly 10 is stacked with and locked with the second stacking assembly 40.

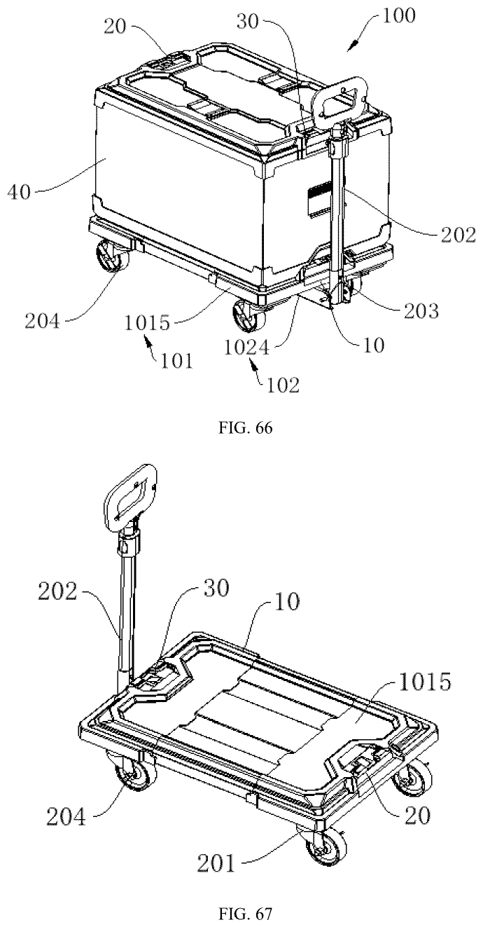

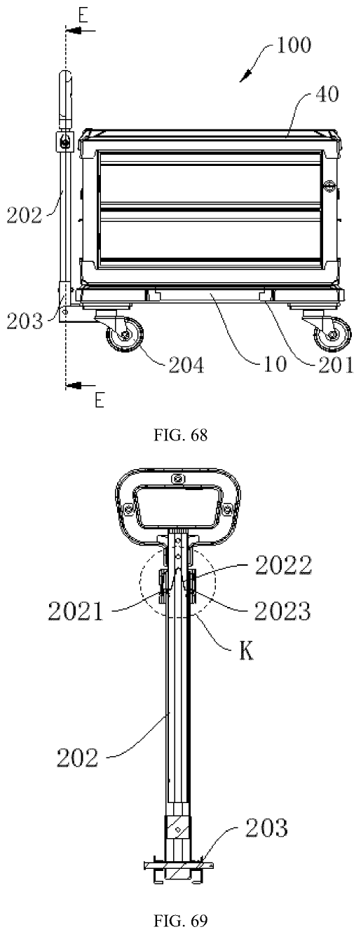

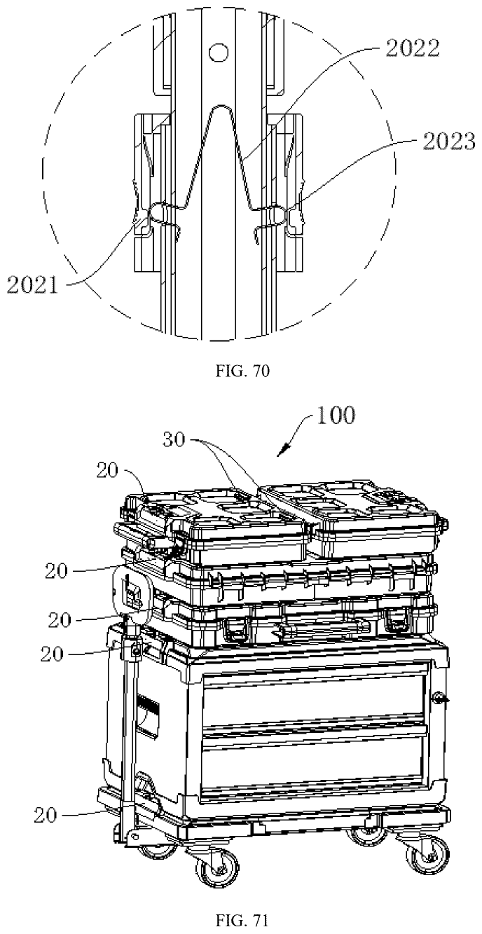

Referring to FIGS. 66 to 70, a tenth embodiment of the present disclosure provides a stacking assembly 1 and a stacking system 100, a conception and a large part of structures of the stacking assembly 1 in the tenth embodiment are substantially the same as those of the stacking assembly 1 in the first embodiment, except that, in the tenth embodiment, in the stacking system 100, lower one of the first stacking assembly 10 and the second stacking assembly 40 is defined as a cart, and the other one of the first stacking assembly 10 and the second stacking assembly 40 is defined as a storage box. The first connecting member 101 of the cart includes a supporting plate 1015, and the second connecting member 102 includes a cart stand 1024. The cart stand 1024 includes a bottom stand 201, a push-pull portion 202, a rotatable portion 203 and a roll 204 and so on. The first mating structure 20 and the third mating structure 30 are both disposed on the supporting plate 1015. The operator can pull the cart to move via the push-pull portion 202 and the roll 204, and adjust a pulling angle of the push-pull portion 202 via the rotatable portion 203. Furthermore, the push-pull portion 202 includes a telescopic rod (not shown) and an adjusting assembly disposed on the telescopic rod. The adjusting assembly includes a button 2021, a third elastic component 2022 and an engaging portion 2023 that are in fit with each other. The operator can adjust a length of the telescopic rod via the adjusting assembly, facilitating users of different heights using.

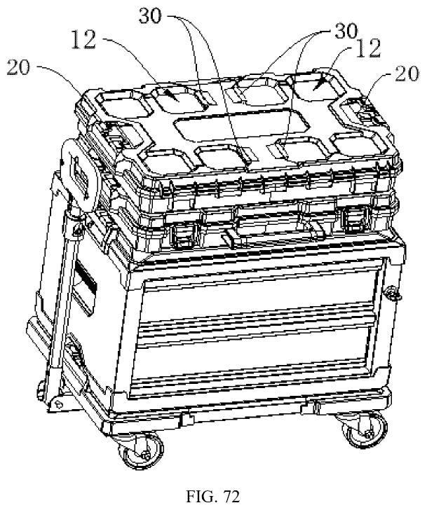

Referring to FIGS. 71 and 72, an eleventh embodiment of the present disclosure provides a plurality of stacking assemblies 1 and a stacking system 100, a conception and a large part of structures of the stacking assembly 1 in the eleventh embodiment are substantially the same as those of the stacking assembly 1 in the first embodiment, except that, in the eleventh embodiment, the stacking system 100 includes a plurality of stacking assemblies 1. The plurality of stacking assemblies 1 include storage boxes with different specifications and carts with different specifications. The carts are disposed on lowest positions of the plurality of stacking assemblies 1, respectively. The plurality of stacking assemblies 1 are stacked with each other along the Z direction. In the stacking system 100, the name of each of the plurality of stacking assemblies 1 is relative. For example, each of the plurality of stacking assemblies 1 is regarded as the second stacking assembly 40 relative to lower one of two adjacent stacking assemblies 1 and as the first stacking assembly 10 relative to upper one of the two adjacent stacking assemblies 1.

The various technical features of the above embodiments can be combined in any way. In order to make the description concise, not all possible combinations of the various technical features in the above embodiments have been described. However, as long as there is no contradiction in the combination of these technical features, they should be considered within the scope of the specification.

The above embodiments only express several embodiments of the present disclosure, and their descriptions are more specific and detailed, but should not be understood as limiting the scope of the disclosure. It should be pointed out that for ordinary skill in the art, several modifications and improvements can be made without departing from the concept of the disclosure, which are within the scope of protection of the disclosure. Therefore, the scope of protection of the present disclosure should be based on the attached claims.

What is claimed is:

1. A stacking assembly having an accommodating space, comprising a first connecting member and a second connecting member,
wherein the first connecting member is configured to form at least one of an upper surface of the stacking assembly and a lower surface of the stacking assembly; the second connecting member is connected to the first connecting member to form the accommodating space, and a material of the first connecting member is different from a material of the second connecting member.

2. The stacking assembly of claim 1, wherein the first connecting member is made of plastic, and the second connecting member is made of metal.

3. The stacking assembly of claim 2, wherein the first connecting member comprises an upper cover and a lower cover, the second connecting member comprises an intermediate housing, the upper cover and the lower cover are mounted on two opposite sides of the intermediate housing, respectively; and an opening is defined on at least one side of the intermediate housing, the upper cover is configured to cover the opening to form the enclosed accommodating space.

4. The stacking assembly of claim 3, further comprising a connecting mechanism, wherein the upper cover is movably connected to the intermediate housing via the connecting mechanism.

5. The stacking assembly of claim 4, wherein the connecting mechanism comprises a sliding component and a sliding mating portion that cooperate with each other, one of the sliding component and the sliding mating portion is disposed on the upper cover, the other one of the sliding component and the sliding mating portion is disposed on the intermediate housing, and the upper cover is capable of being slidably connected to the intermediate housing via cooperation between the sliding component and the sliding mating portion;
the sliding component comprises a slider rail disposed on the upper cover, and the sliding mating portion comprises a slide groove disposed on the intermediate housing;
the sliding groove comprises a side notch and two opposite end openings, the side notch and the two end openings are in communication with each other, an opening of the side notch is disposed towards a side of the stacking assembly, at least one of the two end openings is configured to allow the slider rail to slide from a side of the intermediate housing to the slide groove, so as to prevent the upper cover from detaching from the intermediate housing; and
an inner wall of the slide groove is provided with a stopping protrusion, and when a force applied on the upper cover reaches to a preset value, the slider rail is capable of overcoming a resistance of the stopping protrusion and detaching from the slide groove.

6. The stacking assembly of claim 4, wherein the connecting mechanism comprises a first connecting component and a first engaging assembly, a first side of the upper cover is rotatably connected to the intermediate housing via the first connecting mechanism, and a second side of the upper cover, opposite to the first side of the upper cover, is snapped onto the intermediate housing via the first snapping assembly.

7. The stacking assembly of claim 6, wherein the first engaging assembly comprises a first engaging member and a first mating portion, the first engaging member is disposed on one of the upper cover and the intermediate housing, the first mating portion is disposed on the other one of the upper cover and the intermediate housing, and the first engaging member and the first mating portion both have a mating state and a separating state;
when the first engaging member and the first fitting component are at the mating state, the upper cover is fixedly connected to the intermediate housing, so as to enclose the opening; and when the first engaging member and the first fitting component are at the separating state, the upper cover is capable of flipping relative to the intermediate housing, so as to expose the opening.

8. The stacking assembly of claim 7, wherein the first mating portion comprises a first stopper and a second stopper, the first stopper is connected to the second stopper, the first stopper protrudes from a periphery wall of the intermediate housing, the second stopper protrudes from a side of the first stopper away from the upper cover, an engaging gap is defined between the second stopper and the intermediate housing; and the first engaging member is rotatably mounted on the upper cover, and the first engaging member is capable of being snapped into or detached from the engaging gap via an external force;
a side of the second stopper towards the intermediate housing is provided with a first inclined guiding surface, an inclined direction of the first inclined guiding surface is downward and away from a side of the intermediate housing, the first inclined guiding surface is configured to guide the first engaging member when the first engaging member is detached from the engaging gap; and/or
the first stopper is integrated with the second stopper.

9. The stacking assembly of claim 7, wherein the first snapping assembly further comprises two mounting protrusions, and the first engaging member is a U-shaped rod which is rotatably mounted between the two mounting protrusions.

10. The stacking assembly of claim 3, further comprising a fixing member, wherein a side of the intermediate housing, opposite to the upper cover, is provided with a connecting plate, and the lower cover is connected to the connecting plate via the fixing member; or
further comprising a fixing member, wherein the lower cover comprises a bottom plate and a side plate protruding from a periphery of the bottom plate, and a side wall of the intermediate housing is connected to the side plate of the lower cover via the fixing member.

11. The stacking assembly of claim 3, further comprising a second snapping assembly, wherein the second snapping assembly comprises a second engaging member and a second mating portion, one of the second snapping component and the second mating portion is disposed on a bottom of the intermediate housing, the other one of the second snapping component and the second mating portion is disposed on the lower cover, and the second snapping component is capable of engaging with the second mating portion, such that the lower cover is capable of being connected to the bottom of the intermediate housing;
the second snapping component protrudes from the lower cover, the second snapping component each comprises two catching legs disposed at interval, one side, away from each other, of each of the two catching legs is provided with a limiting protrusion;
the second mating portion comprises a catching slot disposed on the intermediate housing, the two catching legs are capable of deforming and extending to the same snap groove or to two snap grooves, respectively, via an external force, and two limiting protrusions are snapped into the same snap groove or the two snap grooves, respectively, after removing the external force;
one side, away from each other, of each of the two limiting protrusions is provided with a second inclined guiding surface, and the second inclined guiding surface is configured to play a guiding role when the second snapping component is snapped into the snap groove;
an inclination angle of the second inclined guiding surface is in a range of 30 degrees to 45 degrees;
a plurality of second snapping assemblies are disposed along at least one of a X direction and a Y direction.

12. The stacking assembly of claim 2, wherein the first connecting member comprises an upper cover, a connecting frame and a lower cover connected to each other, the upper cover and the lower cover are connected to two opposite ends of the connecting frame, respectively; and the second connecting member is a sheet metal layer that surrounds and covers at least part of a periphery of the connecting frame, to form the enclosed accommodating space together with the upper cover, the connecting frame and the lower cover;
a thickness of the sheet metal layer is regarded as T1, and the thickness T1 of the sheet metal layer is greater than or equal to 1 mm.

13. The stacking assembly of claim 3, wherein the first connecting member is defined as the lower cover, the second connecting member is defined as the intermediate housing, the intermediate housing comprises at least one opening, and the lower cover is mounted on a side, opposite to the opening, of the intermediate housing, so as to form the accommodating space, wherein the accommodating space is semi-enclosed.

14. The stacking assembly of claim 1, wherein the first connecting component is made of a rigid material, and the second connecting member is made of a flexible material;
the rigid material is plastic, and the flexible material is selected from the group consisting of cloth, leather, and flexible plastic, and any combination thereof.

15. The stacking assembly of claim 1, wherein the first connecting member is provided with at least one of a first limiting connecting mechanism and a second limiting connecting mechanism, the first limiting connecting mechanism of one stacking assembly or the second limiting connecting mechanism of one stacking assembly is capable of correspondingly fitting with the second limiting connecting mechanism of another adjacent stacking assembly or the first limiting connecting mechanism of another adjacent stacking assembly, such that the stacking assembly is capable of being stacked with and connected to another adjacent stacking assembly in sequence, and two adjacent stacking assemblies are at least restricted from moving along a stacking direction.

16. The stacking assembly of claim 15, wherein the first limiting connecting mechanism comprises a first mating structure and a third mating structure, and the first mating structure and the third mating structure are disposed on two positions of a top of the stacking assembly, respectively;
the second limiting connecting mechanism comprises a second mating structure and a fourth mating structure, and the second mating structure and the fourth mating structure are disposed on two positions of a bottom of the stacking assembly, respectively; and
the first limiting connecting mechanism and the second limiting connecting mechanism are engaging with each other to be in a locked state; when the first limiting connecting mechanism and the second limiting connecting mechanism are at the locked state, the second mating structure of the stacking assembly and the fourth mating structure of the stacking assembly are capable of being in fit with the first mating structure of another adjacent stacking assembly and the third mating structure of another adjacent stacking assembly, respectively, under pressure of an upper stacking assembly, so as to restrict two adjacent stacking assemblies from moving along a X direction, a Y direction and a Z direction.

17. The stacking assembly of claim 16, wherein the third mating structure is the same as the first mating structure and disposed opposite to the first mating structure, and the fourth mating structure is the same as the second mating structure and disposed opposite to the second mating structure;
the first mating structure comprises a first elastic component and a first moving component, the first elastic component is capable of elastically acting on the first moving component, when the two adjacent stacking assemblies are about to be stacked with each other, the first moving component is capable of moving on lower one of the two adjacent stacking assemblies under pressure of upper one of the two adjacent stacking assemblies; and when the two adjacent stacking assemblies are stacked with each other, the first moving component is capable of being engaged with the second mating structure via an elastic force of the first elastic component, such that the first limiting connecting mechanism and the second limiting connecting mechanism are capable of be at the locked state under the pressure of upper one of the two adjacent stacking assemblies.

18. The stacking assembly of claim 16, further comprising a positioning assembly, wherein when the positioning assembly is disposed at a positioning position, the first limiting connecting mechanism and the second limiting connecting mechanism are capable of being separated from each other to be in an unlocked state; and the two adjacent stacking assemblies are separated from each other at the unlocked state.

19. The stacking assembly of claim 16, wherein the first limiting connecting mechanism and the second limiting connecting mechanism are capable of being separated from each other to be in a reset state, and upper one of the two adjacent stacking assemblies is capable of being detached from lower one of the two adjacent stacking assemblies at the reset state, and the first mating structure is not under stress; and
a position of the first mating structure at the reset state is the same as a position of the first mating structure at the locked state.

20. A stacking system, comprising a plurality of stacking assemblies stacked and locked in sequence along a Z direction, wherein each of the plurality of stacking assemblies is the stacking assembly of claim 1.
